(19) United States
(12) Patent Application Publication
(10) Pub. No.: US 2024/0386415 A1
(43) Pub. Date: Nov. 21, 2024

(54) NON-FUNGIBLE TOKEN GENERATION SYSTEM AND NON-FUNGIBLE TOKEN GENERATION METHOD

(71) Applicants: Bacoor dApps Inc., Hyogo (JP); AI SHOJI CO., LTD., Hyogo (JP)

(72) Inventors: Yukio HARUNA, Hyogo (JP); Hitoshi TAKEUCHI, Hyogo (JP)

(73) Assignees: Bacoor dApps Inc., Hyogo (JP); AI SHOJI CO., LTD., Hyogo (JP)

(21) Appl. No.: 18/283,977

(22) PCT Filed: Mar. 24, 2022
(86) PCT No.: PCT/JP2022/013864

§ 371 Date: Aug. 5, 2024

(30) Foreign Application Priority Data
Mar. 26, 2021 (JP) 2021-053535

(51) Int. Cl. G06Q 20/36; G06Q 20/06

(52) U.S. Cl. CPC G06Q 20/367; G06Q 20/06

(57) ABSTRACT

To make it easier to provide NFTs, it is desired to avoid complexity of having to store NFTs as stocks. A non-fungible token generation system of this disclosure is configured to execute: receiving a non-fungible token request having identification information; identifying a type of a target non-fungible token to be generated, based on the identification information possessed by the non-fungible token request; generating the target non-fungible token of the identified type; and transmitting the generated target non-fungible token. The system can generate a plurality of types of target non-fungible tokens.

### TECHNICAL FIELD

The present disclosure relates to a non-fungible token generation system and a non-fungible token generation method. This application claims priority on Japanese Patent Application No. 2021-053535 filed on Mar. 26, 2021, the entire content of which is incorporated herein by reference.

### BACKGROUND ART

PATENT LITERATURE 1 discloses Ethereum that is an example of a blockchain. Cryptocurrency (virtual currency) used in Ethereum is called Ether. Like legal currency, Ether is fungible. That is, Ether is a kind of fungible token.

Tokens usable on a blockchain such as Ethereum include a non-fungible token (hereinafter also referred to as “NFT”), in addition to a fungible token. The NFT is a token issued according to Ethereum Request for Comments (ERC) 721, for example. The NFT based on the ERC 721 is called an NFT-721 token.

### CITATION LIST

### Patent Literature

PATENT LITERATURE 1: Japanese Laid-Open Patent Publication No. 2019-160316

### SUMMARY OF INVENTION

NFTs may be provided upon request, for the purpose of selling the NFTs. For example, a system that sells NFTs is configured to receive a request from, for example, a person who desires to purchase an NFT, and transmit the purchased NFT to the person. In this case, the system needs to hold in advance a large number of NFTs as stocks, in preparation for purchase of the NFTs.

When the system possesses the NFTs as stocks, stock management becomes complicated. For example, if the number of NFTs as stocks is small, a stockout may occur. In order to avoid such a stockout, an administrator of the system needs to generate a huge amount of NFTs and store the NFTs in the system in advance. In the case of storing a huge amount of NFTs as stocks in the system, the administrator of the system will bear an operation burden of generating the NFTs in advance. In particular, if the system is configured to provide a plurality of types of NFTs, it is necessary to prepare a large number of NFTs for each NFT type, which is extremely complex.

It is also conceivable to generate a necessary NFT after the need to provide the NFT arises, but it may not be easy to obtain information as to what kind of NFT should be generated. Therefore, it may take time to generate the NFT, which may cause complexity.

Accordingly, in order to easily provide NFTs, it is desired to avoid the complexities described above.

One aspect of the present disclosure is a non-fungible token generation system. The system of the disclosure is configured to execute: receiving a non-fungible token request having identification information; identifying a type of a target non-fungible token to be generated, based on the identification information possessed by the non-fungible token request; generating the target non-fungible token of the identified type; and transmitting the generated target non-fungible token. The system of the disclosure is capable of generating a plurality of types of target non-fungible tokens. The system of the disclosure may be a non-fungible token generation system configured to execute a process of generating a non-fungible token, and may include a database including a plurality of material data. The process of generating the non-fungible token may include: receiving a non-fungible token request having identification information; and generating a non-fungible token by using data that is selected based on the received identification information from among the plurality of material data included in the database.

Another aspect of the present disclosure is a non-fungible token generation method executed by a fungible token generation system. The method of the disclosure includes: receiving a non-fungible token request having identification information; generating a target non-fungible token of a type that is identified based on the identification information possessed by the non-fungible token request; and transmitting the generated target non-fungible token. The method of the disclosure may be a non-fungible token generation method executed by a non-fungible token generation system. The non-fungible token generation system may include a database including a plurality of material data. The method may include: receiving a non-fungible token request having identification information; and generating a non-fungible token by using data that is selected based on the received identification information from among the plurality of material data included in the database.

Further details will be described later as an embodiment.

### BRIEF DESCRIPTION OF DRAWINGS

FIG. 1 shows a configuration of a non-fungible token generation system according to a first embodiment.

FIG. 2 illustrates a relationship between box NFTs, pack NFTs, and card NFTs.

FIG. 3 is a timing chart related to an NFT generation process.

FIG. 4 shows an operation screen of a user terminal.

FIG. 5 is a flowchart showing operations and an operation procedure for NFT request in a user terminal.

FIG. 6 is a flowchart of a target NFT generation process.

FIG. 7 shows a configuration of a smart contract.

FIG. 8 is a flowchart of a process performed by a first module.

FIG. 9 is a flowchart of a process performed by a second module.

FIG. 10 is a flowchart of a process performed by a third module.

FIG. 11 is a flowchart of a process performed by a fourth module.

FIG. 12 is a flowchart of a process performed by a fifth module.

FIG. 13 shows a configuration of a non-fungible token generation system according to a second embodiment.

FIG. 14 is a flowchart of a process performed by a smart contract according to the second embodiment.

FIG. 15 shows a configuration of a non-fungible token generation system according to a third embodiment.

FIG. 16 is a flowchart of a process performed by a smart contract according to the third embodiment.

FIG. 17 illustrates generation of a target non-fungible token.

FIG. 18 shows a configuration of a non-fungible token generation system according to a fifth embodiment.

FIG. 19 shows a configuration of a non-fungible token generation system according to a sixth embodiment.

FIG. 20 shows a configuration of a non-fungible token generation system according to a seventh embodiment.

FIG. 21 shows a configuration of a non-fungible token generation system according to an eighth embodiment.

### DESCRIPTION OF EMBODIMENTS

### <1. Outlines of Non-Fungible Token Generation System, and Method Executed by Non-Fungible Token Generation System>

(1) A non-fungible token generation system according to an embodiment (hereinafter, sometimes referred to simply as “system”) is configured to generate a non-fungible token. Transactions of a non-fungible token and a fungible token may be recorded on a blockchain. An owner of a non-fungible token may be recorded on the blockchain. A non-fungible token recorded on the blockchain may be disclosed on the blockchain, and may be referable. A non-fungible token may be used as, for example, an item or a character to be traded in a computer game, a digital trading card, a digital ticket, a digital certificate, or other digital data. A digital trading card is also called a digital collectible card. A non-fungible token may be, as an example, a token issued according to Ethereum Request for Comments (ERC) 721. A non-fungible token sometimes has a unique value that distinguishes the token from other non-fungible tokens. Therefore, a non-fungible token has a unique identifier that makes the token distinguishable from other non-fungible tokens. An identifier of an NFT is, for example, an address indicating the NFT on the blockchain, or another identifier. The identifier of an NFT is also called an NFT-ID.

The system according to the embodiment may be constituted by one computer, or a computer network consisting of a plurality of computers. The computer network may be, for example, the Internet. The computer network may be a P2P computer network. The P2P computer network is, for example, a network in which a plurality of computers are connected via the Internet. The system may include a computer network that constitutes a blockchain.

Provision of a non-fungible token by the system is performed for the purpose of, for example, sale or transfer of the non-fungible token, or exchange of the token with another non-fungible token. A non-fungible token provided by the system for sale, transfer, or exchange is referred to as a target non-fungible token. The system transmits the target non-fungible token, whereby the target non-fungible token is provided.

The system according to the embodiment may be, as an example, configured to execute: receiving a non-fungible token request; generating a target non-fungible token according to the non-fungible token request; and transmitting the target non-fungible token. One or a plurality of target non-fungible tokens may be generated. The system can generate a target non-fungible token with reception of a non-fungible token request as a trigger. Each time the system has received a non-fungible token request, the system can generate a target non-fungible token according to the non-fungible token request. At a time point before reception of a non-fungible token request, the system need not have a target non-fungible token according to the non-fungible token request. That is, the system need not hold stocks of target non-fungible tokens to be provided.

The non-fungible token request is, for example, a command that requests the system to transmit a target non-fungible token. The non-fungible token request is, for example, a command indicating a desire for purchase or transfer of a target non-fungible token, or a command indicating a desire for exchange from a certain non-fungible token to the target non-fungible token. The non-fungible token request may explicitly request the system to transmit the target non-fungible token, or may be a command that does not indicate an explicit request but allows the system to determine that transmission of the target non-fungible token is necessary, as a response to the command. For example, the system may be configured to regard reception of a token as a non-fungible token request. The token regarded as a non-fungible token request is referred to as “request transmission token”. The request transmission token is, for example, a fungible token or a non-fungible token. The non-fungible token request may include a request transmission token, and information other than tokens. The request transmission token may be transmitted together with a command as a non-fungible token request.

The non-fungible token request may be transmitted to the system via the network. A transmission source of the non-fungible token request is, for example, a terminal device of a user who receives a provided target non-fungible token, a computer, of a third party, which is operated for the user who receives the provided target non-fungible token, or any other computer that will receive the target non-fungible token. If transmission of the non-fungible token request includes transmission of the request transmission token, the transmission source of the request transmission token is an account of the user (address of the user on the blockchain) who is the owner of the request transmission token. A transmission destination of the target non-fungible token may be the transmission source of the non-fungible token request, or may be a destination other than the transmission source of the non-fungible token request. The transmission destination of the target non-fungible token may be, for example, the account of the user (address of the user on the blockchain) who is the owner of the request transmission token.

The system may generate and transmit one target non-fungible token in response to one non-fungible token request. The system may generate and transmit a plurality of target non-fungible tokens in response to one non-fungible token request. In this case, the system can collectively provide the plurality of target non-fungible tokens.

The system can generate a plurality of types of target non-fungible tokens. In this case, the system can provide various types of target non-fungible tokens. Moreover, the system may generate a plurality of types of target non-fungible tokens in response to one non-fungible token request. In this case, the system may collectively provide the plurality of types of target non-fungible token. The types of the target non-fungible tokens may be, for example, NFT types (described later) of the target non-fungible tokens, or the categories or genres of the target non-fungible tokens. The types of the target non-fungible tokens may be identified by the system. The categories indicate, for example, categories set on card NFTs described later. The types indicate, for example, types such as “card NFT”, “pack NFT”, and “box NFT” described later. The types of the target non-fungible tokens may be the types of ticket NFTs described later, or the types of certificate NFTs described later.

Here, the “type” may be distinguishable by a distinction of each non-fungible token, but preferably, the “type” is identified by the system as a property common to two or more non-fungible tokens. If a plurality of non-fungible tokens are of the same type, at least parts of configuration data constituting the non-fungible tokens may be common to these tokens. Meanwhile, if a plurality of non-fungible tokens are of different types, the non-fungible tokens may have different configuration data.

The non-fungible token request may have identification information. The identification information may be used for identifying the type of a target non-fungible token to be generated. The non-fungible token request having the identification information allows the system to, upon receiving the non-fungible token request, identity the type of a target non-fungible token to be generated, and generate an appropriate target non-fungible token according to the request. Therefore, the system receiving the non-fungible token request can autonomously generate a target non-fungible token of an appropriate type.

The identification information may be the non-fungible token request itself. For example, if a plurality of commands for non-fungible token requests are prepared according to a plurality of types of target non-fungible tokens, the non-fungible token requests themselves may be used for identifying the types of the target non-fungible tokens.

The identification information may be information included in the non-fungible token request. For example, a command that is commonly used for a plurality of types of target non-fungible token requests may include parameters indicating the types of target non-fungible tokens.

The identification information may be information transmitted together with the non-fungible token request. The information transmitted together with the non-fungible token request is, for example, a non-fungible token, a fungible token, or other digital data to be exchanged for the target non-fungible token. Here, the “information transmitted together with the non-fungible token request” need not be transmitted completely at the same time as the non-fungible token request, and may be information that is related to or associated with the non-fungible token request and that can be regarded as having been transmitted substantially together with the non-fungible token request even if there is some advance or delay. The identification information may be the number or type of request transmission tokens.

If the non-fungible token request includes the request transmission token, the identification information may be, for example, the number of the request transmission tokens. The request transmission token is, for example, a fungible token used as a value for purchasing the target non-fungible token. In this case, the type of the target non-fungible token is identified according to the number of fungible tokens as the request transmission token. The number of non-fungible tokens as the request transmission token may correspond to the price of the target non-fungible token. The identification information may be the number of non-fungible tokens as the request transmission token. The identification information may be the type of the request transmission token. The request transmission token is, for example, another non-fungible token to be exchanged for the target non-fungible token. In this case, the type of the target non-fungible token may be identified according to the type of the non-fungible token as the request transmission token. The identification information may be information as to whether the request transmission token is a non-fungible token or a fungible token. In this case, for example, the target non-fungible token is identified to be of a first type if the request transmission token is a non-fungible token, while the target non-fungible token is identified to be a second type if the request transmission token is a fungible token.

The identification information may be any one of the aforementioned pieces of identification information, or a combination of two or more of them. Using a combination of two or more pieces of information makes it easy to identify an appropriate type among a variety of types.

Generating the target non-fungible token may include generating the target non-fungible token of the type identified based on the identification information. In this case, the system can generate a target non-fungible token of an appropriate type identified based on the identification information possessed by the non-fungible token request. Therefore, the system need not hold in advance a target non-fungible token for each type. The system can generate a non-fungible token by using material data that the system has possessed before reception of the non-fungible token request. The system can determine material data to be used for generation of the non-fungible token, based on the identification information.

(2) Preferably, receiving the non-fungible token request includes receiving a request transmission token that is a fungible token or a non-fungible token, and the type of the target non-fungible token is identified by using, as the identification information, the number or type of the request transmission tokens.

(3) Preferably, the system is configured to be able to receive both a fungible token and a non-fungible token as the request transmission token. Preferably, when the fungible token has been received as the request transmission token, the type of the target non-fungible token is identified based on the number of the fungible tokens having been received as the request transmission token, and when the non-fungible token has been received as the request transmission token, the type of the target non-fungible token is identified based on the type of the non-fungible token having been received as the request transmission token.

(4) The system may be provided with a contract computer that executes a smart contract on a blockchain. The smart contract is software (computer program) executed by a computer constituting a blockchain. The smart contract is implemented on the blockchain so as to be executed on the blockchain, by an administrator of the system, for example. The contract computer is any one of computers constituting the computer network system that constitutes the blockchain. Among the computers constituting the computer network that constitutes the blockchain, the computer serving as the contract computer may dynamically vary.

Preferably, the smart contract is configured to cause the contract computer to execute: receiving a non-fungible token request having the identification information; identifying the type of the target non-fungible token to be generated, based on the identification information possessed by the non-fungible token request; generating the target non-fungible token of the identified type; and transmitting the generated target non-fungible token. The contract computer is preferably able to generate a plurality of types of target non-fungible tokens. In the system, a user computer that receives a selection operation performed by the user may be used. The user computer is preferably configured to specify the number or type of the request transmission tokens according to selection by the selection operation of the user, and transmit the specified number or type of the request transmission tokens to the smart contract. In this case, the number or type of the request transmission tokens according to the selection operation of the user is specified, and the number or type of the request transmission tokens may become the identification information. A transmission source of the request transmission token is, for example, an account of the user on the blockchain (address of the user on the blockchain). In this case, the user computer executes a request transmission token transmission process for the user. The user computer is, for example, a server 350 or a user terminal 300 described later. The user computer only needs to be a computer operating for the user, and may not necessarily be possessed by the user. That is, the user computer may not necessarily be the user terminal 300, and may be a server that is possessed or managed by a person (e.g., the administrator of the system) other than the user.

(5) Preferably, generating the non-fungible token includes generating the target non-fungible token by using data that is selected based on the received identification information from among a plurality of material data. Using the data selected based on the identification information may be using the selected material data itself, or may be using duplicate data of the selected material data. Preferably, generating the non-fungible token may include incorporating configuration data into an initial non-fungible token that is issued by executing a non-fungible token issuance process on the blockchain. Preferably, the configuration data is generated based on the identification information. In the system, preferably, the material data is stored in association with the identification information, or stored in association with the type identified based on the identification information.

The non-fungible token issuance process on the blockchain is performed by executing a command for issuing a non-fungible token. The command for issuing a non-fungible token is, for example, prepared on the blockchain where the non-fungible token is issued. The non-fungible token issuance process is executed on the computer constituting the blockchain. The non-fungible token issued through the non-fungible token issuance process is given a non-fungible token identifier (NFT-ID). A non-fungible token identifier is given to each non-fungible token to make the non-fungible token unique. The non-fungible token identifier may be an address of the non-fungible token on the blockchain, or may be another identifier. The system may acquire the identifier of the issued non-fungible token.

The initial non-fungible token may be a token that is issued through the non-fungible token issuance process, and may be an uncompleted non-fungible token in which configuration data has not yet been incorporated. The configuration data is incorporated in the initial non-fungible token to complete the target non-fungible token. The initial non-fungible token has at least an identifier of a non-fungible token. The initial non-fungible token may include other necessary information, in addition to the identifier. Incorporation of the configuration data may be performed at almost the same time as or after issuance of the initial non-fungible token.

The configuration data is at least one of image data, sound data, and character data, for example. The configuration data may be single data, or a combination of a plurality of data. The image data and the character data may be used for screen display of a non-fungible token possessed by the user or a third party, on a terminal device of the user or the third party. The sound data may be outputted together with display of the image data or the character data, on the terminal device of the user or the third party possessing the non-fungible token. The image data may be moving picture data, or still picture data. The image data may correspond to the subject of a trading card described later, the content of a ticket described later, the content of a warranty certificate described later, or a product to be covered by a warranty.

Since the configuration data may be generated based on the type identified based on the identification information, configuration data appropriate for the type may be incorporated in the initial non-fungible token. In target non-fungible tokens of the same type, at least one common data corresponding to the type may be incorporated as the configuration data. That is, if a plurality of target non-fungible tokens are of the same type, these target non-fungible tokens may have at least one common configuration data. Meanwhile, if a plurality of target non-fungible tokens are of different types, these target non-fungible tokens may have differences in configuration data according to the difference in type. Even with such difference in type between the target non-fungible tokens, the system can identify the type from the non-fungible token request to determine appropriate configuration data.

(6) Preferably, the target non-fungible token has an identifier indicating duplicate data of the selected data.

Preferably, the identifier indicating the duplicate data is a uniform resource identifier indicating the duplicate data. The aforementioned non-fungible token issuance process is preferably performed after reception of the non-fungible token request. In this case, it is not necessary to issue the initial non-fungible token before reception of the non-fungible token request, and prepare the same as a stock in advance. Preferably, the configuration data is generated as unique data for the target non-fungible token, by using the material data that is determined based on the identification information from among a plurality of material data that can also be used for generation of other configuration data. In this case, the configuration data incorporated in each target non-fungible token becomes data unique to the target non-fungible token, so that scarcity value is easily generated. The configuration data may be generated by duplicating the material data that is commonly used for generation of other configuration data. When certain configuration data is stored with a file name different from that of another configuration data or stored at a different location from the other configuration data, the certain configuration data becomes unique data distinguishable from the other configuration data even if these data have the same content. Data such as a serial number, characters, a mark, or image data being added to the configuration data obtained by duplicating the material data makes the configuration data more easily distinguishable from the other configuration data. Preferably, incorporating the configuration data into the initial non-fungible token includes associating the initial non-fungible token with the identifier of the configuration data. The identifier of the configuration data is, for example, a uniform resource identifier (URI) of the configuration data. The URI is, for example, a uniform resource locator (URL). The generated configuration data is stored in, for example, a data server on the Internet, and the URI or the URL may serve as an identifier indicating the configuration data stored in the data server. The URI may be a uniform resource name (URN).

(8) Preferably, the system is configured to further execute identifying the number of the target non-fungible tokens to be generated, based on the identification information. In this case, the identification information is also used as information for identifying the number of the target non-fungible tokens to be generated.

The system may be configured to include a first computer and a second computer. Each of the first computer and the second computer may be constituted by a single computer, or a plurality of computers connected via the network. The first computer may be the computer network system constituting the blockchain. The first computer and the second computer are preferably connected to each other via the network. The second computer preferably includes a plurality of material data that are candidates or origins of the configuration data.

Preferably, the first computer is configured to execute a first process including at least: receiving the non-fungible token request; identifying the type by using the information possessed by the non-fungible token request; and issuing the initial non-fungible token by executing the non-fungible token issuance process. The first process includes the non-fungible token issuance process on the blockchain, and therefore is preferably executed by the smart contract implemented on the blockchain.

Preferably, the second computer is configured to execute a second process of selecting material data to be the configuration data from among the plurality of material data, according to the type identified by the first computer. The second process may further include storing, as the configuration data, a duplicate of the selected material data. A URI (URL) indicating the stored configuration data is given from the second computer to the smart contract (first computer), and the smart contract (first computer) can associate the URI (URL) with the initial non-fungible token. The second computer is preferably a computer provided separately from the blockchain. The second computer is, for example, a server computer managed by the administrator of the system.

Executing the first process and the second process on separate computers allows the respective processes to be separately managed, thereby making the management easier. In particular, the second process handles the material data that can be diverse. Therefore, the second process being separated from the first process can avoid or reduce a change in the material data on the first process side even if there is a change in the material data on the second process side. In addition, the smart contract may have restrictions on the amount of program codes (number of steps) that are describable. Therefore, when the first process is executed by the smart contract, the first process being separated from the second process can easily avoid an increase in the number of steps in the first process.

Preferably, the second process is executed when the second computer detects that the first computer has issued the initial non-fungible token. In this case, the second process can be started with the issuance of the initial non-fungible token by the first computer as a trigger. The second computer may detect the issuance of the initial non-fungible token by the first computer, by receiving a notification from the first computer. Also, the second computer may monitor the behavior of the first computer (the smart contract executing the first process), and may spontaneously detect the issuance of the initial non-fungible token without a notification from the first computer. Since issuance of non-fungible tokens and the contents of issued non-fungible tokens have been recorded on the blockchain so that they can be referred to, the second computer may detect the issuance of the initial non-fungible token by the first computer, by checking the non-fungible token issuance status on the blockchain and the details thereof.

The first computer (smart contract) may issue an initial non-fungible token having information indicating the type of the target non-fungible token. In this case, on the blockchain, the second computer can refer to the information possessed by the issued initial non-fungible token, identify the type of the target non-fungible token, determine configuration data appropriate for the type, and incorporate the configuration data into the initial non-fungible token.

The second computer may be configured to acquire a generation condition including information that indicates the type of the target non-fungible token, from the first computer.

(9) Receiving the non-fungible token request may include receiving a request transmission token that is a non-fungible token. The non-fungible token that is the request transmission token preferably has the identification information used for identifying the type of the target non-fungible token to be generated. The identification information possessed by the non-fungible token that is the request transmission token is, for example, information indicating the type of the non-fungible token that is the request transmission token. The system can identify the target non-fungible token to be generated, based on the identification information possessed by the non-fungible token that is the request transmission token. The identification information may have information used as configuration data to be incorporated in the target non-fungible token. In this case, the system can generate the target non-fungible token by using the information possessed by the non-fungible token that is the request transmission token, as at least a part of the configuration data to be incorporated in the target non-fungible token.

(10) The identification information possessed by the non-fungible token request preferably includes data indicating any of the plurality of material data. The system is preferably configured to include a generation private key for generating the target non-fungible token, and generate the target non-fungible token by using the generation private key.

A method according to the embodiment may be a non-fungible token generation method executed by a non-fungible token generation system. The method includes: receiving a non-fungible token request having identification information; generating a target non-fungible token of a type that is identified based on the identification information possessed by the non-fungible token request; and transmitting the generated target non-fungible token. A method according to the embodiment may be a non-fungible token generation method executed by a non-fungible token generation system. The non-fungible token generation system may include a database including a plurality of material data. The method may include: receiving a non-fungible token request having identification information; and generating a non-fungible token by using data that is selected based on the received identification information from among the plurality of material data included in the database. A system according to the embodiment may be a non-fungible token generation system configured to execute a process of generating a non-fungible token, and may include a database including a plurality of material data. The process of generating the non-fungible token may include: receiving a non-fungible token request having identification information; and generating a non-fungible token by using data that is selected based on the received identification information from among the plurality of material data included in the database. Preferably, the system is configured to include a generation private key for generating the non-fungible token, and generate the non-fungible token by using the private key.

A computer program according to the embodiment causes a processor to execute at least one of the processes of the disclosure. The computer program is stored in a computer-readable non-transitory storage medium.

### <2. Examples of Non-Fungible Token Generation System and Method Executed by Non-Fungible Token Generation System>

Hereinafter, preferable embodiments will be described with reference to the drawings. The following description describes examples of preferred embodiments, and does not limit the present invention.

### 2.1 First Embodiment: Card NFT Generation System

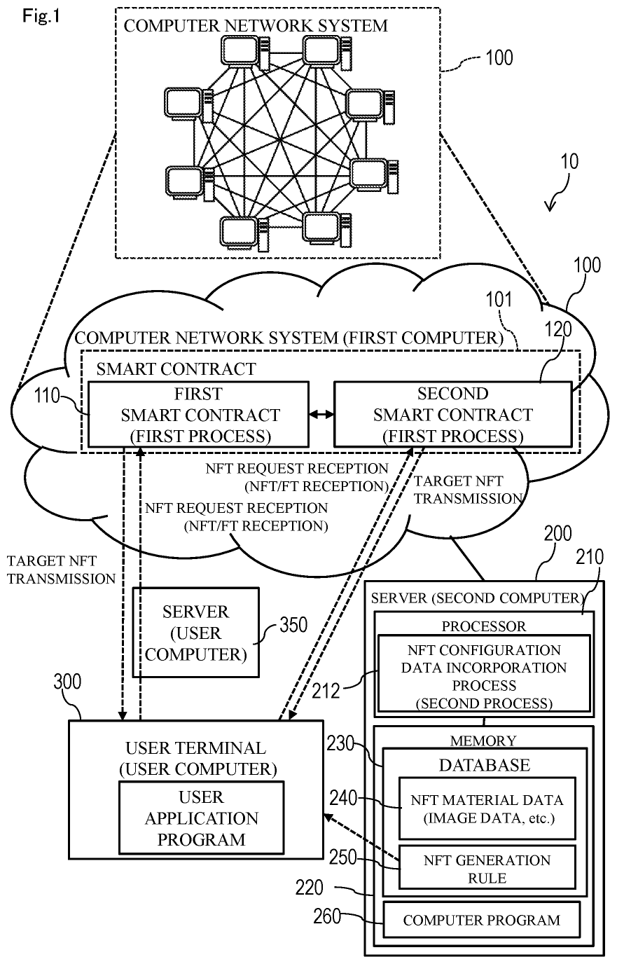

FIG. 1 shows an example of a non-fungible token generation system (NFT generation system) 10 according to the first embodiment. The system 10 according to the first embodiment may include a smart contract 101 implemented on a computer network system 100 such as a blockchain. The smart contract 101 is software (computer program) implemented on the computer network system 100 (first computer) such as a blockchain, and automatically executes a predetermined protocol. The smart contract 101 of this embodiment has a contract address that is an address on the blockchain. The smart contract 101 is stored in the contract address. The smart contract 101 is executed by being called by another computer. The computer that calls the smart contract 101 is, for example, a server 350 operating for a user, or a user terminal 300. The server 350 is, for example, an application server that is accessed by the user terminal 300. The server 350 may constitute the system 10. The server 350 may be provided on a network such as the Internet. The smart contract 101 is configured to execute an NFT generation process (first process) according to the embodiment. The blockchain is constituted by a P2P computer network in which a plurality of computers are connected to each other, as shown in FIG. 1. The smart contract 101 may be executed by any of the plurality of computers constituting the computer network system 100.

The system 10 according to the first embodiment may include a server 200 (second computer). The server 200 supports, for example, the process (first process; NFT generation process) performed in the smart contract 101. The server 200 may support a process performed in the user terminal 300 described later. The server 200 may also perform a process for managing the system 10. The system 10 may include the aforementioned server 350 as one of the components of the system 10.

The server 200 (second computer) is connected to the computer network system 100 (first computer) on which the smart contract 101 is implemented, via a network such as the Internet. The server 200 and the smart contract 101 are communicable with each other.

The server 200 is constituted by a computer including a processor 210 and a memory 220. The same applies to the server 350. The server 200 and the server 350 each may be constituted by a plurality of computers. The memory 220 is connected to the processor 210. The memory 220 includes, for example, a primary storage device and a secondary storage device. The primary storage device is, for example, a RAM. The secondary storage device is, for example, a hard disk drive (HDD) or a solid state drive (SSD). The memory 220 includes a computer program 260 to be executed by the processor 210. The processor 210 reads out the computer program 260 stored in the memory 220, and executes the computer program 260. The computer program 260 has a program code for the process to be executed by the server 200. The process to be executed by the server 200 includes, for example, an NFT configuration data incorporation process 212 (second process) described later.

The memory 220 includes a database 230. The database 230 includes, for example, NFT material data 240 (database for material data). The database 230 includes a plurality of material data. The system 10 may generate a non-fungible token by using data selected from among the plurality of material data. The database 230 may further include an NFT generation rule 250. The NFT material data 240 and the NFT generation rule 250 will be described later. The database 230 already has the material data before reception of a non-fungible token request (NFT request) described later. Therefore, in generating an NFT, the system 10 need not receive, from the outside, the material data that the system 10 already possess.

The system 10 according to the first embodiment generates a digital card NFT for providing services of selling and exchanging the digital card NFT. The system 10 may provide a service of distributing the digital card NFT for free. The system 10 is communicable, via the network, with a terminal 300 (user terminal) possessed by a user who desires to purchase or exchange the digital card NFT. The user terminal 300 is, for example, a smartphone, a tablet, a wearable device, a personal computer, or another computer possessed by the user. The system 10 according to the first embodiment is configured to be able to generate a plurality of types of NFTs (digital card NFTs; target NFTs). The system 10 according to the first embodiment is configured as follows. That is, upon receiving a non-fungible token request generated based on an operation of a user who desires to acquire an NFT, the system 10 executes a process of generating the NFT, and recording, on the blockchain, that the owner of the generated NFT is the user. For example, the system 10 according to the first embodiment generates an NFT of the type selected by the user from among the plurality of types of NFTs, and transmits the NFT to the user (user account on the blockchain). The database 230 may include material data respectively corresponding to the plurality of types. The system 10 may select material data corresponding to the type of the NFT to be produced from among the plurality of material data included in the database 230, and generate the NFT by using the selected data. The system 10 may generate the NFT using data received from the outside of the system 10, in addition to the material data.

The digital card NFT provided by the system 10 according to the first embodiment is obtained by subjecting a digital trading card to non-fungible tokenization, for example. The “non-fungible tokenization” means that data or an identifier such as a URI directly or indirectly indicating the data is recorded as a token on the blockchain. The digital trading card is a trading card that is digitized. The digital trading card is displayed on a computer screen. Hereinafter, the digital card NFT is referred to as a card NFT (cardNFT). The card NFT can be transacted with any third party. The trading record of the card NFT and past and present owners of the card NFT are recorded on the blockchain. The card NFT and other NFTs can also be transacted on computers in market places outside the system 10.

Trading cards are also called collectible cards. The trading cards have various images corresponding to the subjects thereof, and are sold for collection or exchange. For example, the images corresponding to the subjects are: images of entertainers, singers, athletes, and other celebrities; images of characters of comics, games, animations, etc.; and images of items, vehicles, machines, tools, animals, plants, etc., that appear in games. In order to display a card NFT, the corresponding image is displayed on the screen of the computer of the owner of the card NFT or the computer of a third party who is allowed to refer to the card NFT. The trading cards may have different values depending on the images or the like corresponding to the subjects. Trading cards that are issued less may have scarcity value.

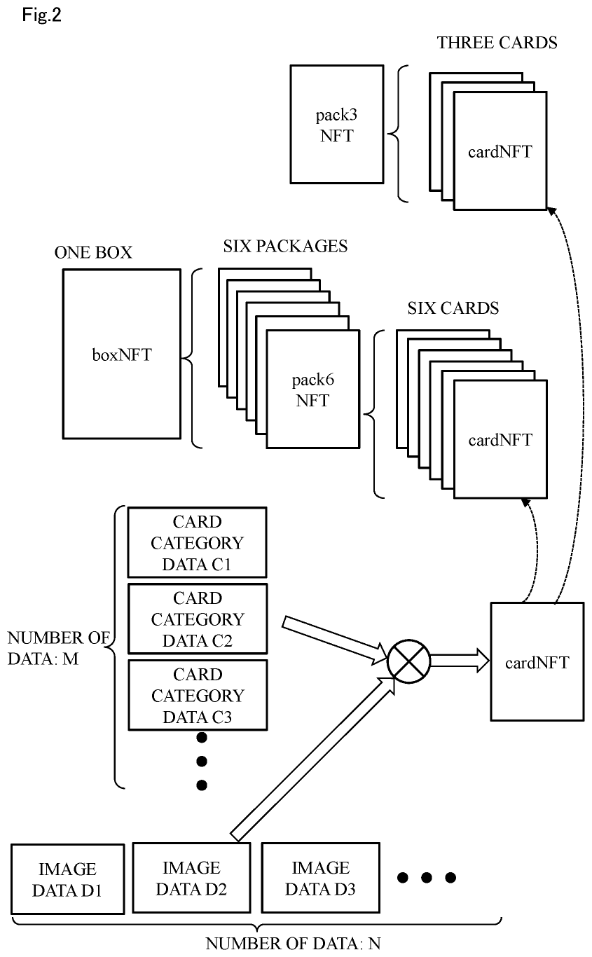

As shown in FIG. 2, the card NFTs according to the embodiment are configured such that image data D1, D2, D3, etc., corresponding to the subjects of the card NFTs are incorporated therein. In addition, a plurality of categories C1, C2, C3 are set on the card NFTs according to the embodiment. The categories C1, C2, C3 are the types of the card NFTs set by the system administrator, and indicate the ranks, genres, properties, etc., of the card NFTs. Even when card NFTs have the same image data D1, D2, or D3, these card NFTs are treated as different types of card NFTs if different categories C1, C2, C3 are given to the cards. Therefore, if the number of categories is M and the number of image data, corresponding to the subjects, prepared in the system 10 is N, the number of types of card NFTs is M×N. Therefore, a great many types of card NFTs exist, which enhances the pleasure of collecting and exchanging card NFTs by the users.

In this embodiment, the card NFTs may be sold or traded in a unit called a pack. One pack is exchangeable for one or a plurality of card NFTs through the system 10. That is, an owner of a pack has the right of exchanging the pack for one or a plurality of card NFTs. However, the user cannot know what kind of card NFT the pack is exchanged for, before the exchange is actually performed. In the first embodiment, a pack is also non-fungible tokenized. A pack that is non-fungible tokenized is referred to as a pack NFT (packNFT).

In this embodiment, the pack NFT just indicates that it is exchangeable for one or a plurality of card NFTs, and does not indicate what kind of card NFT the pack NFT is actually exchanged for, at a time point before the exchange. In addition, the pack NFT is not provided with the card NFT for which the pack NFT is exchanged, and does not have information related to the card NFT for which the pack NFT is exchanged. Therefore, even the user who owns the pack NFT cannot know what kind of card NFT the pack NFT is exchanged for, before the exchange is actually performed. As a result, the user who owns the pack NFT can enjoy an experience similar to having an actual unopened pack. That is, an actual unopened pack enclosing an actual trading card provides the user with such a pleasure that the user cannot know what kind of trading card is enclosed, before he/she opens the pack. Likewise, the pack NFT also provides the user with such a pleasure that the user cannot know what kind of card NFT the user can obtain, before the pack NFT is exchanged for the card NFT.

The pack NFT can be transacted with any third party. The trading record and the past and present owners of the card NFT are recorded on the blockchain. Since the pack NFT can also be transacted, it can be resold as well. If the sale of a specific type of pack NFT is limited, the pack NFT is expected to have scarcity value.

As shown in FIG. 2, examples of the pack NFT include: a pack 6 NFT to be exchanged for six card NFTs; and a pack 3 NFT to be exchanged for three card NFTs. Since a plurality of types of pack NFTs are prepared, convenience of the user is improved.

In this embodiment, pack NFTs may be sold or transacted in a unit called a box. One box is exchanged for a plurality of pack NFTs through the system. Here, for example, as shown in FIG. 2, one box is exchanged for six pack 6 NFTs. That is, an owner of a box has the right of exchanging the box for six packs. In the first embodiment, a box is also non-fungible tokenized. The box that is non-fungible tokenized is referred to as a box NFT (boxNFT).

In this embodiment, the box NFT just indicates that it is exchangeable for a plurality of pack NFTs, and does not indicate which pack NFTs the box NFT is actually exchanged for, at a time point before the exchange. In addition, the box NFT is not provided with the pack NFTs to be exchanged for the box NFT, and does not have information related to the pack NFTs to be exchanged for the box NFT.

The box NFT can be transacted with any third party. The trading record and the past and present owners of the box NFT are recorded on the blockchain. Since the box NFT can also be transacted, it can be resold as well. If the sale of a specific type of box NFT is limited, the box NFT is expected to have scarcity value.

As described above, the NFTs provided by the system 10 according to the first embodiment include three types of NFTs, i.e., the card NFT, the pack NFT, and the box NFT. That is, there are at least three types of NFTs as NFTs that the system 10 of the first embodiment provides. Moreover, there are M categories as categories into which the card NFTs provided by the system 10 of the first embodiment are classified. That is, there are at least M types of card NFTs provided by the system 10 according to the first embodiment. Thus, the system 10 according to the first embodiment can provide the user with a plurality of types of NFTs. In this embodiment, the type (or the category) set for each NFT may be identified by the system 10, based on identification information possessed by the NFT. The identification information may be image data possessed by each NFT. In this case, the type of the image data represents the type of the NFT. The identification information may be characters or a symbol representing the type of the NFT having the identification information. If an NFT being a request transmission token has identification information indicating the type of the NFT, the NFT itself being the request transmission token can be used as identification information for identifying the type of the target NFT. Specifically, the identification information possessed by the NFT being the request transmission token may be used as identification information for identifying the type of the target non-fungible token to be generated.

If there are N types of image data to be incorporated in card NFTs, at least N types of card NFTs are provided by the system 10 according to the first embodiment. Moreover, when the categories of the card NFTs and the types of image data to be incorporated in the card NFTs are integrated, there are M×N types of card NFTs. There may be a plurality of types of pack NFTs and a plurality of types of box NFTs. The card NFTs or the pack NFTs to be obtained through exchange may be differentiated according to the types thereof.

A box NFT and a pack NFT each may serve as a request transmission token (request transmission non-fungible token) that can be exchanged for a target non-fungible token through the system 10. That is, depending on whether a request transmission token received by the system 10 is a box NFT or a pack NFT, the type of a target non-fungible token to be generated differs.

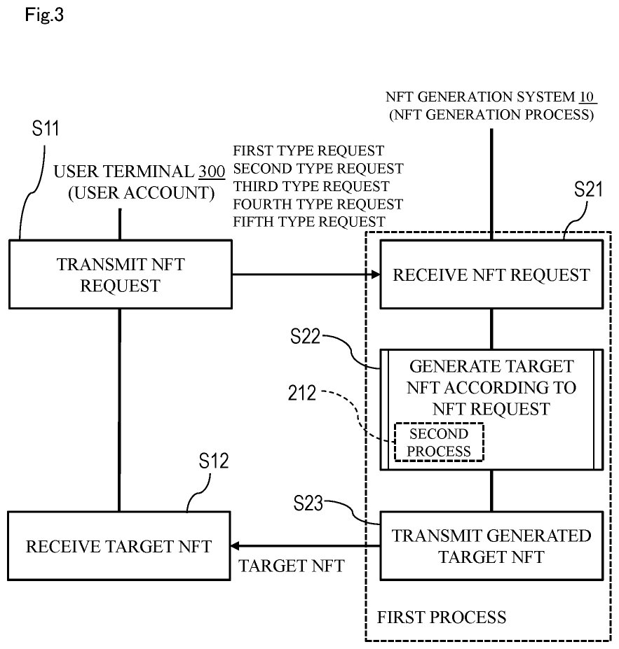

FIG. 3 shows a flow of an NFT generation process executed by the system 10. The NFT generation process shown in FIG. 3 is executed by the smart contract 101, but the server 200 participates in a part (second process) of the process. Of the NFT generation process, a part to be executed by the smart contract 101 (first computer; contract computer) is referred to as a first process, and a part to be executed by the server 200 (second computer) is referred to as a second process. The manner of role division between the smart contract 101 and the server 200 described here is merely an example. The manner of role division is not particularly limited, or role division may not necessarily be performed.

In the NFT generation process shown in FIG. 3, first, a non-fungible token request (NFT request) is transmitted from a computer such as the user terminal 300 to the system 10 (step S11). The NFT request is received by, for example, the smart contract 101 (step S21). The NFT request may be transmitted from the server 350 to the smart contract 101, or may be transmitted from the user terminal 300 to the smart contract 101 via the server 350. The user has a blockchain address for using the blockchain. The blockchain address is expressed like 0x00000, for example. The blockchain address is also called a blockchain account. The user has a private key (secret key) corresponding to the blockchain account. The private key is stored in, for example, the user terminal 300 or another device. The private key is used for an electronic signature of a transaction to be recorded on the blockchain.

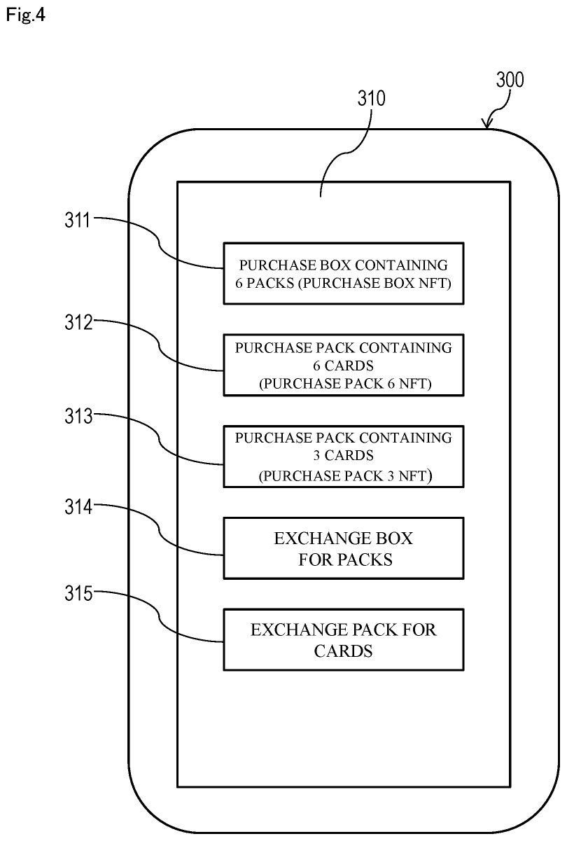

FIG. 4 shows an operation screen 310 for an NFT request in the user terminal 300 (user computer). In the user terminal 300, a user application program for purchase, exchange, and management of NFTs is installed. The operation screen 310 shown in FIG. 4 is displayed on a display of the user terminal 300 by the user application program. The user application program can also display an NFT possessed by the user or an NFT that the user intends to purchase or exchange, on the screen of the user terminal 300. The operation screen 310 shown in FIG. 4 may be displayed on the display of the user terminal 300 by the server 350 (user computer) accessed by the user terminal 300.

As shown in FIG. 4, the operation screen 310 is provided with buttons 311, 312, 313, 314, 315. The button 311 receives an operation of purchasing a box (box NFT) containing 6 packs. The button 312 receives an operation of purchasing a pack (pack 6 NFT) containing 6 cards. The button 313 receives an operation of purchasing a pack (pack 3 NFT) containing 3 cards. The button 314 receives an operation of exchanging a box NFT for packs containing 6 cards (pack 6 NFTs). The operation of exchanging a box NFT for packs containing 6 cards (pack 6 NFTs) may be called a box NFT opening operation (open box operation). The button 315 receives an operation of exchanging a pack NFT (pack 6 NFT or pack 3 NFT) for 6 or 3 card NFTs.

Here, on the operation screen 310, an operation of selecting the button 311 by the user is referred to as “first type request operation”, an operation of selecting the button 312 is referred to as “second type request operation”, an operation of selecting the button 313 is referred to as “third type request operation”, an operation of selecting the button 314 is referred to as “fourth type request operation”, and an operation of selecting the button 315 is referred to as “fifth type request operation”. Thus, the user can perform the operations of selecting the buttons 311, 312, 313, 314, 315 on the operation screen 310. The user terminal 300 or the server 350 being the user computer can receive the selection operation performed by the user.

In the first embodiment, the first type request is a request for a box NFT, the second type request is a request for a pack 6 NFT, the third type request is a request for a pack 3 NFT, the fourth type request is a request for pack 6 NFTs, and the fifth type request is a request for card NFTs. Here, each request is requesting the system 10 to transmit the corresponding NFT.

The first type request is also a request for exchange of a required number of fungible tokens for a box NFT. A fungible token is cryptocurrency (virtual currency) such as Ethereum or a bitcoin, for example. Hereinafter, a fungible token is also referred to as “FT”.

The second type request is also a request for exchange of a required number of FTs for a pack 6 NFT. The third type request is also a request for exchange of a required number of FTs for a pack 3 NFT. The required number of FTs may vary depending on the type of the NFT to be exchanged. Thus, each request may be requesting the system 10 to provide an NFT in exchange for FTs.

The fourth type request is also a request for exchange of a box NFT for pack 6 NFTs. The fifth type request is also a request for exchange of a pack 6 NFT or a pack 3 NFT for a card NFT. Thus, each request may be requesting the system 10 to provide a certain type of NFT in exchange for another type of NFT to be given to the system 10. In this case, the type of the NFT to be provided by the system 10 may depend on the type of the NFT to be given to the system 10.

As described above, in this embodiment, the user terminal 300 or the server 350 being the user computer is configured to specify the number of fungible tokens or the type of non-fungible token to be transmitted as the request transmission token, according to the selection of the user through the button selecting operation, and transmit the specified number or type of request transmission tokens to the smart contract 101.

In this embodiment, the smart contract 101 is configured to, for example, execute generation/transmission of the target non-fungible token only when it has received a predetermined number of tokens or a predetermined type of token (request transmission token). That is, the smart contract 101 is configured not to generate/transmit the target non-fungible token even when it has received tokens whose number is other than the predetermined number, and is configured not to generate/transmit the target non-fungible token even when it has received a token whose type is other than the predetermined type. Therefore, the user terminal 300 or the server 350 being the user computer functions to transmit only an appropriate request transmission token to the smart contract 101, according to the selection by the selection operation of the user.

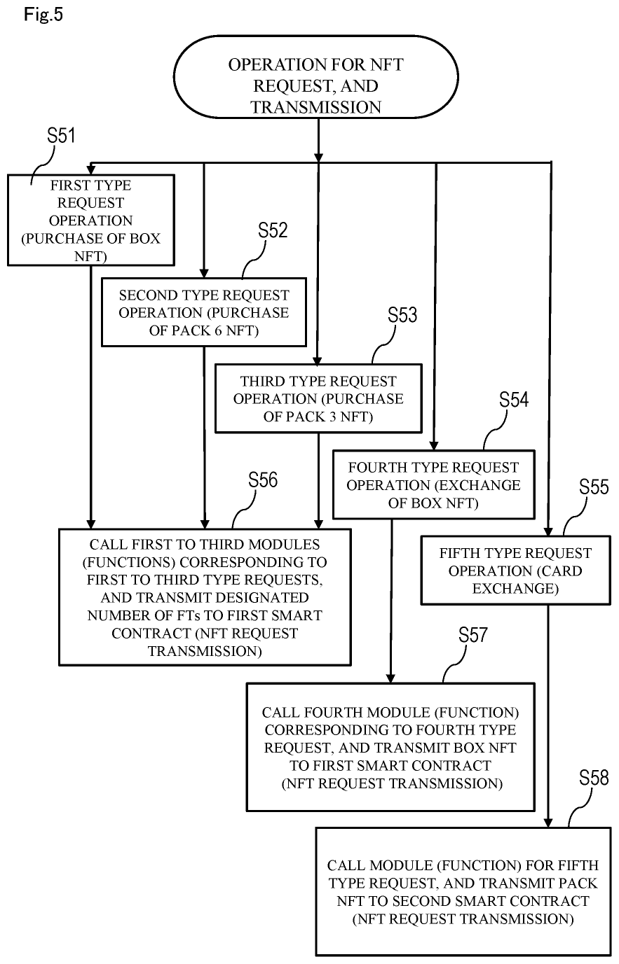

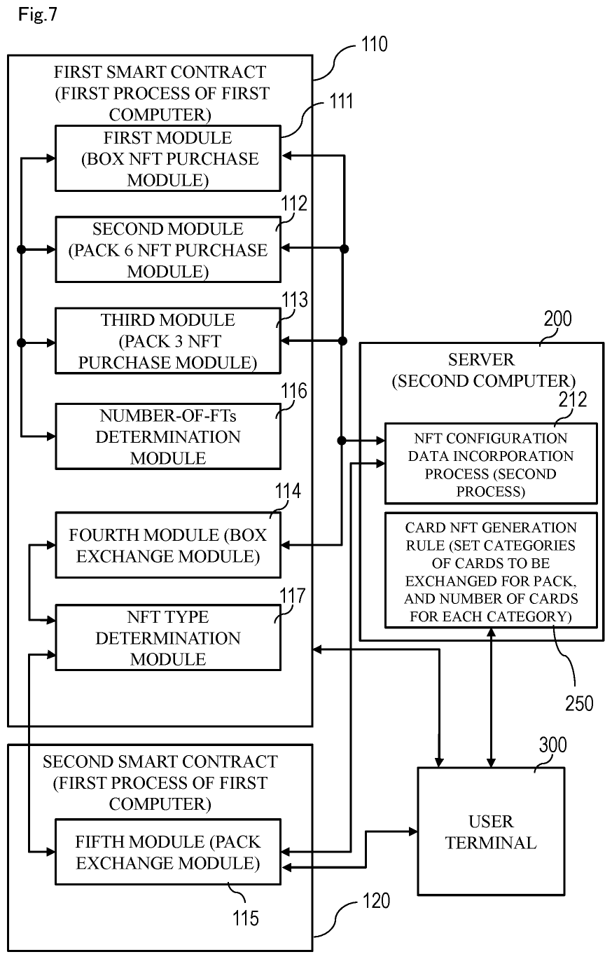

FIG. 5 shows an operation and a procedure for an NFT request in the user terminal 300. Apart or the entirety of the procedure shown in FIG. 5 may be executed by the server 350 accessed by the user terminal 300. If the user desires to purchase a box NFT, the user performs an operation of selecting the button 311, i.e., a first type request operation (step S51). Upon receiving the first type request operation, the user terminal 300 or the server 350 being the user computer transmits the first type request to the smart contract 101 (see step S11 in FIG. 3). In the case where the first type request operation has been performed, transmission of the NFT request includes: calling a first module 111 (see FIG. 7) corresponding to the first type request in the smart contract 101; and transmitting, to the smart contract 101, a required number of FTs to obtain the box NFT (step S56 in FIG. 5). Transmission of the FTs is performed by, for example, transmitting the FTs from the user address (user account) on the blockchain to the contract address of the smart contract 101. Transmission of the FTs from the user account to the smart 01 may be executed by, for example, the server 350. In response to the selection by the user (selection of the button 311) on the operation screen 310, the user terminal 300 or the server 350 being the user computer specifies that tokens to be transmitted (request transmission token) are FTs, and the required number of FTs, and transmits the specified number of FTs to the smart contract 101.

If the user desires to purchase a pack 6 NFT, the user performs an operation of selecting the button 312, i.e., a second type request operation (step S52). Upon receiving the second type request operation, the user terminal 300 or the server 350 being the user computer transmits the second type request to the smart contract 101 (see step S11 in FIG. 3). In the case where the second type request operation has been performed, transmission of the NFT request includes: calling a second module 112 (see FIG. 7) corresponding to the second type request in the smart contract 101; and transmitting, to the smart contract 101, a required number of FTs to obtain the pack 6 NFT (step S56 in FIG. 5). In response to the button 312 being selected by the user, the user terminal 300 or the server 350 being the user computer specifies that tokens to be transmitted (request transmission token) are FTs, and the required number of FTs, and transmits the specified number of FTs to the smart contract 101.

If the user desires to purchase a pack 3 NFT, the user performs an operation of selecting the button 313, i.e., a third type request operation (step S53). Upon receiving the third type request operation, the user terminal 300 or the server 350 being the user computer transmits the third type request to the smart contract 101 (see step S11 in FIG. 3). In the case where the third type request operation has been performed, transmission of the NFT request includes: calling a third module 113 (see FIG. 7) corresponding to the third type request in the smart contract 101; and transmitting, to the smart contract 101, a required number of FTs to obtain the pack 3 NFT (step S56 in FIG. 5). In response to the button 313 being selected by the user, the user terminal 300 or the server 350 being the user computer specifies that tokens to be transmitted (request transmission token) are FTs, and the required number of FTs, and transmits the specified number of FTs to the smart contract 101.

If the user desires to exchange a box NFT for pack 6 NFTs, the user performs an operation of selecting the button 314, i.e., a fourth type request operation (step S54). Upon receiving the fourth type request operation, the user terminal 300 or the server 350 being the user computer transmits the fourth type request to the smart contract 101 (see step S11 in FIG. 3). In the case where the fourth type request operation has been performed, transmission of the NFT request includes: calling a fourth module 114 (see FIG. 7) corresponding to the fourth type request in the smart contract 101; and transmitting the box NFT to the smart contract 101 (step S57 in FIG. 5). In response to the button 314 being selected by the user, the user terminal 300 or the server 350 being the user computer specifies that the type of the token to be transmitted (request transmission token) is a box NFT, and transmits the specified box NFT to the smart contract 101.

If the user desires to exchange a pack 6 NFT or a pack 3 NFT for a card NFT, the user performs an operation of selecting the button 315, i.e., a fifth type request operation (step S55). Upon receiving the fifth type request operation, the user terminal 300 or the server 350 being the user computer transmits the fifth type request to the smart contract 101 (see step S11 in FIG. 3). In the case where the fifth type request operation has been performed, transmission of the NFT request includes: calling a fifth module 115 (see FIG. 7) corresponding to the fifth type request in the smart contract 101; and transmitting the pack 6 NFT or the pack 3 NFT to the smart contract 101 (step S58 in FIG. 5). Which one of the pack 6 NFT and the pack 3 NFT is transmitted depends on a selection operation performed by the user. The fifth type request operation may be an operation of selecting one of the pack 6 NFT and the pack 3 NFT possessed by the user. In response to the selection operation of the user, the user terminal 300 or the server 350 being the user computer specifies that the type of the token to be transmitted (request transmission token) is a pack 6 NFT or a pack 3 NFT, and transmits the specified pack 6 NFT or pack 3 NFT to the smart contract 101.

Referring back to FIG. 3, upon receiving the NFT request transmitted from the user terminal 300 (step S21), the system 10 generates the target non-fungible token (target NFT) in response to the NFT request (step S22). The system 10 has a generation private key (secret key) for generating the target NFT, and generates the target NFT by using the generation private key. For example, the system 10 affixes an electronic signature to a transaction for generating the target NFT by using the generation private key. The transaction with the electronic signature is recorded on the blockchain. The generation private key allows the system 10 to generate the target NFT to be acquired by the user, without using a private key of the user who will acquire the NFT. Then, the system 10 transmits the generated target NFT to the user terminal 300 (user account) (step S23). The transmitted target NFT is received by the user terminal 300 (step S12). Transmission of the target NFT only needs to be an operation of generating, on the blockchain, a state in which the owner of the target NFT is changed to the user, and the target NFT is held in the account of the user. That is, the system 10 only needs to record, on the blockchain, the fact that the owner of the generated target NFT is the user.

That is, the target NFT need not be actually transmitted to a specific device, i.e., the user terminal 300, and only needs to be transmitted to the user account (blockchain address of the user) that the user can access via the terminal 300. The user account is, for example, an account on the blockchain, and such an account can be identified by a unique address on the blockchain. The owner of the target NFT transmitted to the user account is the user, and the user can refer to the target NFT displayed on the user terminal 300. The system 10 may recognize the transmission source of the NFT request by the user account as described above, and may recognize the transmission destination of the target NFT by the user account. The system 10 may recognize the transmission source of the NFT request as the transmission destination of the target NFT. That is, the system 10 may transmit the target NFT to the transmission source of the NFT request. The system 10 may acquire data indicating the transmission destination of the target NFT upon receiving the NFT request, or may acquire the data after reception of the NFT request.

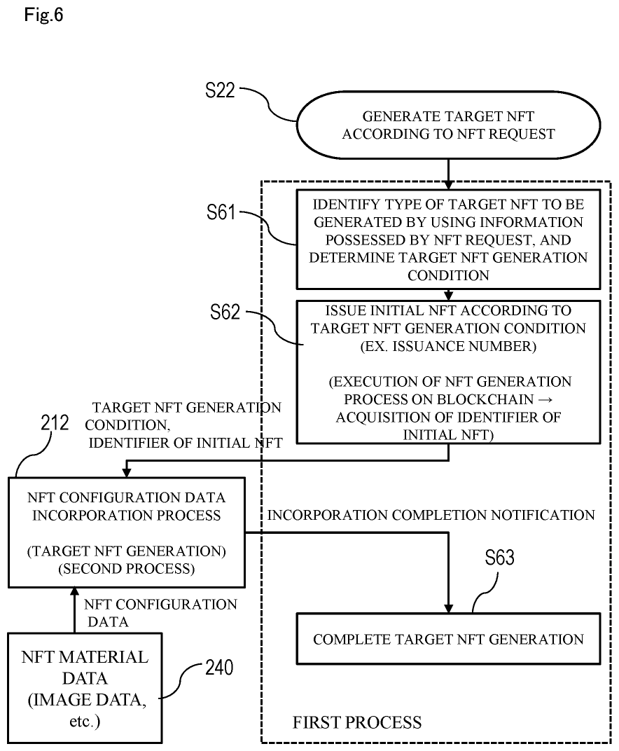

FIG. 6 shows the target NFT generation process described above (step S22). Using the information (identification information) possessed by the received NFT request, the system 10 identifies the type of the target NFT to be generated (step S61). Here, the “identification information” used for identifying the type of the target NFT is the NFT request itself. That is, the type of the target NFT to be generated is identified depending on which one of the first type request, the second type request, the third type request, the fourth type request, and the fifth type request is the type of the NFT request. The “identification information” may be the number or type of request transmission tokens, and the type of the target NFT to be generated is identified according to the number or type of request transmission tokens. The “identification information” may also be other data possessed by the NFT request.

The system 10 determines a generation condition for the target NFT, according to the identified type (step S61). The generation condition is used for generating the target NFT. The generation condition indicates, for example, what kind of target NFT is to be generated. The generation condition may indicate the number (issuance number) of target NFTs to be generated. The above “identification information” may indicate the number of target NFTs to be generated. The generation condition will be described later.

The system 10 issues an initial NFT according to the generation condition (step S62). For example, the system 10 issues initial NFTs as many as the issuance number indicated by the generation condition. The initial NFT issuance is achieved by executing an NFT issuance command that is prepared on the blockchain used by the system 10. When the NFT issuance command has been executed on the blockchain, the computer constituting the blockchain receives the NFT issuance command and executes an NFT issuance process on the blockchain. The issued NFT is recorded on a ledger on the blockchain, and the record is disclosed. The NFT issued on the blockchain is given an identifier (NFT address or NFT-ID) unique to the NFT. After execution of the NFT issuance command for issuing the initial NFT, the system 10 waits until the initial NFT is issued on the blockchain. The waiting time varies among blockchains, and the shorter, the better. After the waiting time has elapsed, the system 10 can acquire the identifier of the issued initial NFT.

Subsequently, the system 10 executes the NFT configuration data incorporation process 212 (see FIG. 2 and FIG. 6). The NFT configuration data incorporation process 212 includes: acquiring the generation condition for the target NFT and the identifier of the initial NFT; and associating the identifier of the initial NFT with NFT configuration data according to the generation condition (e.g., the type of the target NFT). A plurality of NFT material data 240 to be candidates for the NFT configuration data are stored in the database 230. In the NFT configuration data incorporation process 212, according to the generation condition, the system 10 determines NFT material data corresponding to the type of the target NFT from among the plurality of NFT material data 240, and generates configuration data by using the material data. The determined material data may be used as configuration data as it is. The configuration data is, for example, image data and character data. The system 10 performs a process of associating the generated configuration data with the identifier of the initial NFT. Thus, the initial NFT and the configuration data are integrated with each other, thereby generating the target NFT. Through the above processes, generation of the target NFT is completed (step S63). The incorporation process 212 may be executed by the smart contract 101 (the contract computer executing the smart contract 101; first computer), or the server 200 (second computer).

In this embodiment, as an example, steps S21, S22, S23 are referred to as the first process, and the process 212 is referred to as the second process. As an example, the first process is executed by the smart contract 101 (first computer) shown in FIG. 1, and the second process is executed by the server 200 (second computer). In addition, as an example, in the target NFT generation process (step S22), steps S61, S62, S63 correspond to the first process, and the incorporation process 212 corresponds to the second process.

The NFT configuration data incorporation process 212 is executed when the server 200 has detected issuance of the initial NFT by the smart contract 101. Detection of issuance of the NFT is performed by, for example, the server 200 monitoring occurrence of an NFT issuance event in the smart contract 101. That is, the process 212 is an event driven type process. The NFT issuance event is, for example, an operation that occurs in the smart contract 101 when the smart contract 101 executes an NFT issuance command.

Upon detecting occurrence of the NFT issuance command, the server 200 acquires the generation condition for the target NFT and the identifier of the initial NFT. The generation condition and the identifier of the initial NFT are acquired from the smart contract 101. According to the acquired generation condition, the server 200 determines NFT material data corresponding to the type of the target NFT from among the plurality of NFT material data 240, and generates configuration data. The server 200 executes a process of associating the generated configuration data with the identifier of the initial NFT held by the smart contract 101, thereby completing the target NFT. That is, the system 10 generates the target NFT by using the data selected based on the identification information from among the plurality of material data 240. Selecting the data based on the identification information may include selecting the data based on the type of the target NFT that is identified based on the identification information. The configuration data is incorporated in the generated target NFT. The NFT incorporating the configuration data has, for example, a uniform resource identifier (URI) indicating the configuration data. Here, the URI indicating the configuration data may be included in metadata of the NFT. A URI indicating the metadata may be included in index data of the NFT. The issuance of the initial NFT (step S62) and the incorporation process 212 may not necessarily be separately performed, and the NFT incorporating the configuration data may be generated in step S62. Upon completing the process 212, the server 200 transmits an incorporation completion notification to the smart contract 101. Upon receiving the incorporation completion notification, the smart contract 101 recognizes that generation of the target NFT has been completed (step S63), and transmits the target NFT (step S23 in FIG. 3). Transmission of the target NFT is accompanied by an owner recording operation on the blockchain so that the new owner of the target NFT becomes the transmission destination (user account). That is, transmission of the target NFT is transfer or sale of the target NFT.

In this embodiment, as an example, the smart contract 101 includes a first smart contract 110 and a second smart contract 120 as shown in FIG. 1 and FIG. 7. That is, in this embodiment, software constituting the first smart contract 110 and software constituting the second smart contract are implemented on the blockchain so as to be executed in the computer network system for the blockchain. The first smart contract 110 and the second smart contract 120 are communicable with each other.

The first smart contract 110 shown in FIG. 7 includes, as an example, the first module 111, the second module 112, the third module 113, the fourth module 114, a number-of-fungible-tokens determination module (number-of-FTs determination module) 116, and an NFT type determination module 117. The second smart contract 120 shown in FIG. 7 includes, as an example, the fifth module 115. Here, the “module” may be a module as software. The “module” is, for example, a function, a procedure, or a subroutine defined in a computer program. Each module may be executed by any computer on the computer network constituting the blockchain.

The first module 111 is a box NFT purchase module that defines a process for purchasing a box NFT. The second module 112 is a pack 6 NFT purchase module that defines a process for purchasing a pack 3 NFT. The third module 113 is a pack 6 NFT purchase module that defines a process for purchasing a pack 3 NFT. The fourth module 114 is a box exchange module that defines a process for exchanging a box NFT for packs containing 6 cards (pack 6 NFTs). The fifth module 115 is a pack exchange module that defines a process for exchanging a pack NFT (pack 6 NFT or pack 3 NFT) for 6 or 3 card NFTs.

The number-of-FTs determination module 116 is a module that is called when determination is made as to whether or not the number of FTs received by the smart contract 101 (first smart contract 110) matches the number of FTs required for purchase of the target NFT. The NFT type determination module 117 is a module that is called when the type of the NFT received by the smart contract 101 (first smart contract 110 or second smart contract 120) is determined. The NFT type determination module 117 may serve as a token determination module for determining the type of the received token, i.e., determining whether the received token is an FT or an NFT.

In this embodiment, the first module 111 is called if the NFT request is the first type request, the second module 112 is called if the NFT request is the second type request, the third module 113 is called if the NFT request is the third type request, the fourth module 114 is called if the NFT request is the fourth type request, and the fifth module 115 is called if the NFT request is the fifth type request. That is, the module to be called is determined based on the type of the NFT request. The module to be called may be determined based on the number or type of request transmission tokens transmitted to the smart contract 101. Thus, the system 10 identifies the type of the NFT request, and selects the module 111, 112, 113, 114, or 115 to be executed. The system 10 executes the first module 111 if the NFT request is the first type request, executes the second module 112 if the NFT request is the second type request, executes the third module 113 if the NFT request is the third type request, executes the fourth module 114 if the NFT request is the fourth type request, and executes the fifth module 115 if the NFT request is the fifth type request.

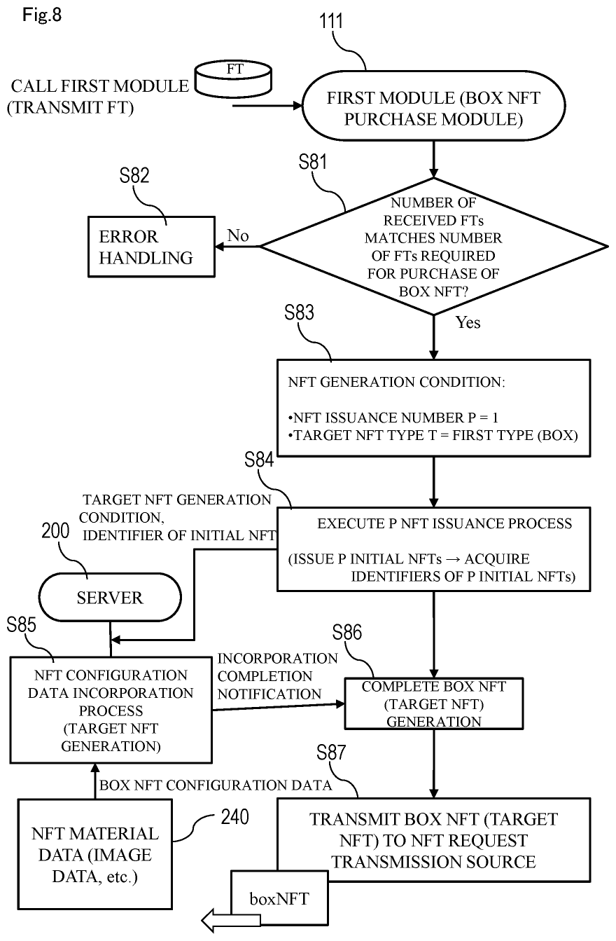

FIG. 8 shows the procedure of a process performed in the first module 111 (box NFT purchase module). First, the first smart contract 110 receives the first type request from the user terminal 300 or the server 350 being the user computer. A required number of FTs are also received together with the first type request. The reception of the required number of FTs for purchase of the box NFT may be regarded as reception of the first type request. Transmission of FTs to the first module 111 and the other modules 112, 113 is accompanied by an operation for changing the owner of the FTs from the transmission source (user account) to the account of the smart contract 101 or the administrator of the smart contract 101. This means that the FTs are paid by the user. The owner change is recorded on the blockchain.

Since the first type request is a call for the first module 111, operation of the first module 111 is started. In the process in the first module 111, first, determination is made as to whether or not the number of the FTs received together with the first type request matches the number of FTs required for purchase of the box NFT (step S81). This determination is performed by the number-of-FTs determination module 116. The number of FTs required for purchase of the box NFT is notified to the user terminal in advance.

If the number of the received FTs does not match the number of FTs required for purchase of the box NFT, error handling, such as notifying this fact to the user terminal 300, is performed (step S82). In this case, the process in the first module 111 is ended. The smart contract 101 may specify that the module to start operating is the first module 111 upon receiving the required number of FTs for acquiring the box NFT, and may cause the specified first module 111 to start operating. That is, the number of FTs represents identification information, and the number of FTs being the identification information determines the generation condition. In this case, steps S81, S82 can be omitted, and the process may be started from step S83. Also, if the smart contract 101 can receive both an FT and an NFT as in this embodiment, the smart contract 101 may have a function of determining whether the received token (request transmission token) is an FT or an NFT.

If the number of the received FTs matches the number of FTs required for purchase of the box NFT, generation condition for the target NFT is determined (step S83). Here, the generation condition is determined such that target NFT issuance number P=1, and target NFT type T=first type (box). This generation condition indicates that one box NFT of the first type should be issued as the target NFT. The generation condition may be determined according to the number of the received FTs.

Subsequently, according to the generation condition, a process of issuing P (one) initial NFT is executed, and the identifier of the initial NFT is acquired (step S84). The initial NFT issuance process may be performed such that the issued initial NFT includes data indicating the generation condition such as “target NFT type T=first type (box)”.

Upon detecting the initial NFT having been issued, the server 200 acquires the generation condition for the target NFT and the identifier of the initial NFT, and executes the NFT configuration data incorporation process, thereby generating a box NFT as the target NFT (step S85). The server 200 may acquire the generation condition such as “initial NFT type T” by referring to the record of the initial NFT on the blockchain.

In the NFT configuration data incorporation process, according to the target NFT type T=the first type (box), configuration data for the box NFT (e.g., image data for the box NFT, and character data indicating the name or the like of the box NFT) is selected from among a plurality of NFT material data 240. The plurality of material data 240 included in the database 230 include the material data for the box NFT of the first type (box). The system 10 may select the material data to be the configuration data, based on the type T identified based on the received identification information. Data other than the material data 240 (e.g., the serial number of the box NFT) may be added to the configuration data. Then, the configuration data for the box NFT is incorporated in the initial NFT to complete the box NFT. The configuration data may be incorporated when the initial NFT is issued. When the box NFT has been completed, the server 200 transmits a completion notification to the smart contract 101. Upon receiving the incorporation completion notification, the smart contract 101 recognizes that generation of the box NFT has been completed (step S86), and transmits the box NFT to the user account that is the transmission source of the FTs (step S87).

As described above, the user can obtain the box NFT in exchange for paying the FTs. The system 10 according to the embodiment generates the box NFT after payment of the FTs, and therefore need not hold the box NFT to be given to the user, before payment of the FTs. It may be identified by the number of the FTs transmitted to the smart contract 101 that the NFT to be generated by the system 10 is a box NFT.

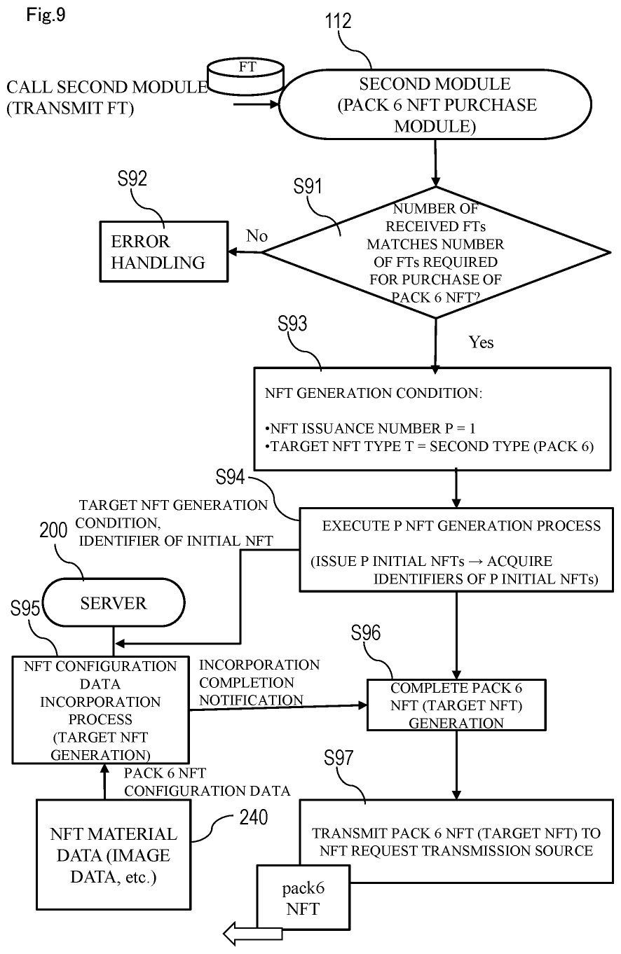

FIG. 9 shows the procedure of a process performed in the second module 112 (pack 6 NFT purchase module). First, the first smart contract 110 receives the second type request from the user terminal 300 or the server 350 being the user computer. A required number of FTs are also received together with the second type request. The reception of the required number of FTs for purchase of the pack 6 NFT may be regarded as reception of the second type request.

Since the second type request is a call for the second module 112, operation of the second module 112 is started. In the process in the second module 112, first, determination is made as to whether or not the number of the FTs received together with the second type request matches the number of FTs required for purchase of the pack 6 NFT (step S91). This determination is performed by the number-of-FTs determination module 116. The number of FTs required for purchase of the pack 6 NFT is notified to the user terminal in advance.

If the number of the received FTs does not match the number of FTs required for purchase of the pack 6 NFT, error handling, such as notifying this fact to the user terminal 300, is performed (step S92). In this case, the process in the second module 112 is ended. The smart contract 101 may specify that the module to start operating is the second module 112 upon receiving the required number of FTs for acquiring the pack 6 NFT, and may cause the specified second module 112 to start operating. That is, the number of FTs represents identification information, and the number of FTs being the identification information determines the generation condition. In this case, steps S91, S92 can be omitted, and the process may be started from step S93.

If the number of the received FTs matches the number of FTs required for purchase of the pack 6 NFT, generation condition for the target NFT is determined (step S93). Here, the generation condition is determined such that target NFT issuance number P=1, and target NFT type T=second type (pack 6). This generation condition indicates that one pack 6 NFT of the second type should be issued as the target NFT. The generation condition may be determined according to the number of the received FTs.

Subsequently, according to the generation condition, a process of issuing P (one) initial NFT is executed, and the identifier of the initial NFT is acquired (step S94). The initial NFT issuance process may be performed such that the issued initial NFT includes data indicating the generation condition such as “target NFT type T=second type (pack 6)”.

Upon detecting the initial NFT having been issued, the server 200 acquires the generation condition for the target NFT and the identifier of the initial NFT, and executes the NFT configuration data incorporation process, thereby generating a pack 6 NFT as the target NFT (step S95). The server 200 may acquire the generation condition such as “target NFT type T” by referring to the record of the initial NFT on the blockchain. In the NFT configuration data incorporation process, according to the target NFT type T=the second type (pack 6), configuration data for the pack 6 NFT (e.g., image data for the pack 6 NFT, and character data indicating the name or the like of the pack 6 NFT) is selected from among a plurality of NFT material data 240. The plurality of material data 240 included in the database 230 include the material data for the pack 6 NFT of the second type (pack 6). The system 10 may select the material data to be the configuration data, based on the type T identified based on the received identification information. Data other than the material data 240 (e.g., the serial number of the pack 6 NFT) may be added to the configuration data. Then, the configuration data for the pack 6 NFT is incorporated in the initial NFT to complete the pack 6 NFT. The configuration data may be incorporated when the initial NFT is issued. When the pack 6 NFT has been completed, the server 200 transmits a completion notification to the smart contract 101. Upon receiving the incorporation completion notification, the smart contract 101 recognizes that generation of the pack 6 NFT has been completed (step S96), and transmits the pack 6 NFT to the user account that is the transmission source of the FTs (step S97).

As described above, the user can obtain the pack 6 NFT in exchange for paying the FTs. The system 10 according to the embodiment generates the pack 6 NFT after payment of the FTs, and therefore need not hold the pack 6 NFT to be given to the user, before payment of the FTs. It may be identified by the number of the FTs transmitted to the smart contract 101 that the NFT to be generated by the system 10 is a pack 6 NFT.

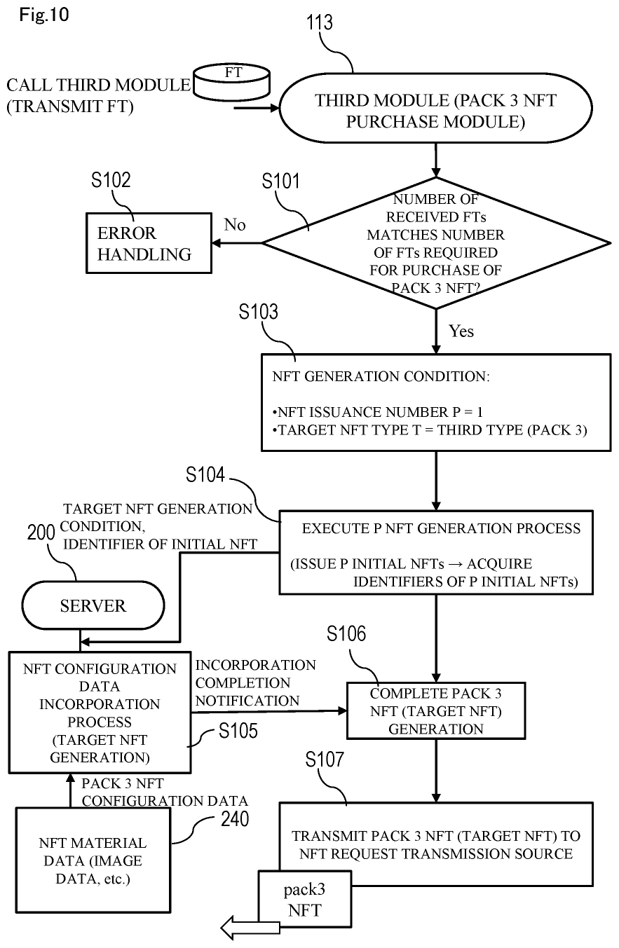

FIG. 10 shows the procedure of a process performed in the third module 113 (pack 3 NFT purchase module). First, the first smart contract 110 receives the third type request from the user terminal 300 or the server 350 being the user computer. A required number of FTs are also received together with the third type request. The reception of the required number of FTs for purchase of the pack 3 NFT may be regarded as reception of the third type request.

Since the third type request is a call for the third module 113, operation of the third module 113 is started. In the process in the third module 113, first, determination is made as to whether or not the number of the FTs received together with the third type request matches the number of FTs required for purchase of the pack 3 NFT (step S101). This determination is performed by the number-of-FTs determination module 116. The number of FTs required for purchase of the pack 3 NFT is notified to the user terminal in advance.

If the number of the received FTs does not match the number of FTs required for purchase of the pack 3 NFT, error handling, such as notifying this fact to the user terminal 300, is performed (step S102). In this case, the process in the third module 113 is ended. The smart contract 101 may specify that the module to start operating is the third module 113 upon receiving the required number of FTs for acquiring the pack 3 NFT, and may cause the specified third module 113 to start operating. That is, the number of FTs represents identification information, and the number of FTs being the identification information determines the generation condition. In this case, steps S101, S102 can be omitted, and the process may be started from step S103.

If the number of the received FTs matches the number of FTs required for purchase of the pack 3 NFT, generation condition for the target NFT is determined (step S103). Here, the generation condition is determined such that target NFT issuance number P=1, and target NFT type T=third type (pack 3). This generation condition indicates that one pack 3 NFT of the third type should be issued as the target NFT. The generation condition may be determined according to the number of the received FTs.

Subsequently, according to the generation condition, a process of issuing P (one) initial NFT is executed, and the identifier of the initial NFT is acquired (step S104). The initial NFT issuance process may be performed such that the issued initial NFT includes data indicating the generation condition such as “target NFT type T=third type (pack 3)”.

Upon detecting the initial NFT having been issued, the server 200 acquires the generation condition of the target NFT and the identifier of the initial NFT, and executes the NFT configuration data incorporation process, thereby generating a pack 3 NFT as the target NFT (step S105). The server 200 may acquire the generation condition such as “target NFT type T” by referring to the record of the initial NFT on the blockchain. In the NFT configuration data incorporation process, according to the target NFT type T=the third type (pack 3), configuration data for the pack 3 NFT (e.g., image data for the pack 3 NFT, and character data indicating the name or the like of the pack 3 NFT) is selected from among a plurality of NFT material data 240. The plurality of material data 240 included in the database 230 include the material data for the pack 3 NFT of the third type (pack 3). The system 10 may select the material data to be the configuration data, based on the type T identified based on the received identification information. Data other than the material data 240 (e.g., the serial number of the pack 3 NFT) may be added to the configuration data. Then, the configuration data for the pack 3 NFT is incorporated in the initial NFT to complete the pack 3 NFT. The configuration data may be incorporated when the initial NFT is issued. When the pack 3 NFT has been completed, the server 200 transmits a completion notification to the smart contract 101. Upon receiving the incorporation completion notification, the smart contract 101 recognizes that generation of the pack 3 NFT has been completed (step S106), and transmits the pack 3 NFT to the user account that is the transmission source of the FTs (step S107).

As described above, the user can obtain the pack 3 NFT in exchange for paying the FTs. The system 10 according to the embodiment generates the pack 3 NFT after payment of the FTs, and therefore need not hold the pack 3 NFT to be given to the user, before payment of the FTs. It may be identified by the number of the FTs transmitted to the smart contract 101 that the NFT to be generated by the system 10 is a pack 3 NFT.

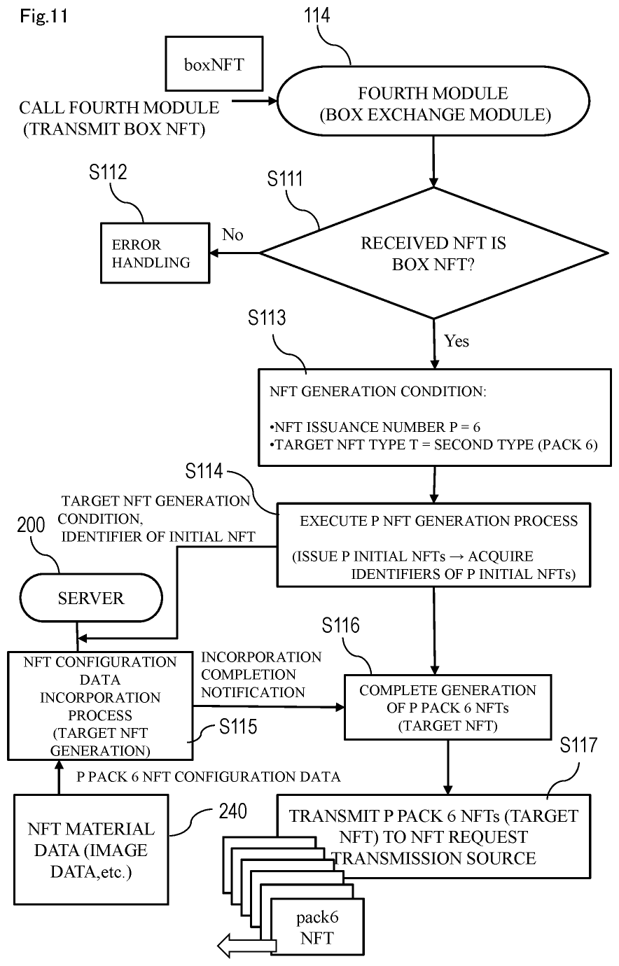

FIG. 11 shows the procedure of a process performed in the fourth module 114 (box exchange module). First, the first smart contract 110 receives the fourth type request from the user terminal 300 or the server 350 being the user computer. An NFT (box NFT) is also received together with the fourth type request. Transmission of the box NFT to the fourth module 114 is accompanied by an operation for changing the owner of the box NFT from the transmission source (user account) to the account of the smart contract 101 or the administrator of the smart contract 101. That is, the box NFT is transferred from the user to the smart contract. The owner change of the NFT is recorded on the blockchain. The reception of the box NFT may be regarded as reception of the fourth type request.

Since the fourth type request is a call for the fourth module 114, operation of the fourth module 114 is started. In the process in the fourth module 114, first, determination is made as to whether or not the type of the NFT received together with the fourth type request is a box NFT (step S111). This determination is performed by the NFT type determination module 117. The determination of the type of the NFT is performed based on, for example, information that is included in the determination target NFT and includes the type T, or the type T indicated by the record of the determination target NFT on the blockchain.

If the type of the received NFT is not a box NFT, error handling, such as notifying this fact to the user terminal 300, is performed (step S112). In this case, the process in the fourth module 114 is ended. The smart contract 101 may specify that the module to start operating is the fourth module 114 upon receiving the box NFT, and may cause the specified fourth module 114 to start operating. That is, the type of the received NFT (box NFT) represents identification information, and the type of the NFT being the identification information determines the generation condition. In this case, steps S111, S112 can be omitted, and the process may be started from step S113.

If the type of the received NFT is a box NFT, generation condition for the target NFT is determined (step S113). Here, the generation condition is determined such that target NFT issuance number P=6, and target NFT type T=second type (pack 6). This generation condition indicates that six pack 6 NFTs of the second type should be issued as the target NFT. That is, the box NFT is exchanged for six pack 6 NFTs. The generation condition may be determined according to the type of the received NFT being a box NFT.

Subsequently, according to the generation condition, a process of issuing P (six) initial NFTs is executed, and the identifiers of the initial NFTs are acquired (step S114). The initial NFT issuance process may be performed such that the issued initial NFTs include data indicating the generation condition such as “target NFT type T=second type (pack 6)”.

Upon detecting the initial NFTs having been issued, the server 200 acquires the generation condition of the target NFT and the identifiers of the initial NFTs, and executes the NFT configuration data incorporation process, thereby generating pack 6 NFTs as the target NFT (step S115). The server 200 may acquire the generation condition such as “target NFT type T” by referring to the record of the initial NFTs on the blockchain. In the NFT configuration data incorporation process, according to the target NFT type T=the second type (pack 6), configuration data for the pack 6 NFT (e.g., image data for the pack 6 NFT, and character data indicating the name or the like of the pack 6 NFT) is selected from among a plurality of NFT material data 240. The plurality of material data 240 included in the database 230 include material data for the pack 6 NFT of the second type (pack 6). The system 10 may select the material data to be the configuration data, based on the type T identified based on the received identification information. Data other than the material data 240 (e.g., the serial numbers of the pack 6 NFTs) may be added to the configuration data. The configuration data is generated for each of the six NFTs. The configuration data for the pack 6 NFT is incorporated in each of the six initial NFTs to complete six pack 6 NFTs. The configuration data may be incorporated when the initial NFTs are issued. When the six pack 6 NFTs have been completed, the server 200 transmits a completion notification to the smart contract 101. Upon receiving the incorporation completion notification, the smart contract 101 recognizes that generation of the six pack 6 NFTs has been completed (step S116), and transmits the pack 6 NFTs to the user account that is the transmission source of the box NFT (step S117).

As described above, the user can obtain the six pack 6 NFTs in exchange for giving the box NFT. That is, the user can enjoy an experience similar to opening a box containing six packs. The system 10 according to the embodiment generates the pack 6 NFTs after transfer of the box NFT, and therefore need not hold the pack 6 NFTs to be given to the user, before transfer of the box NFT. It may be identified that the NFTs to be generated by the system 10 are pack 6 NFTs, by the fact that the type of the NFT transmitted to the smart contract 101 is a box NFT.

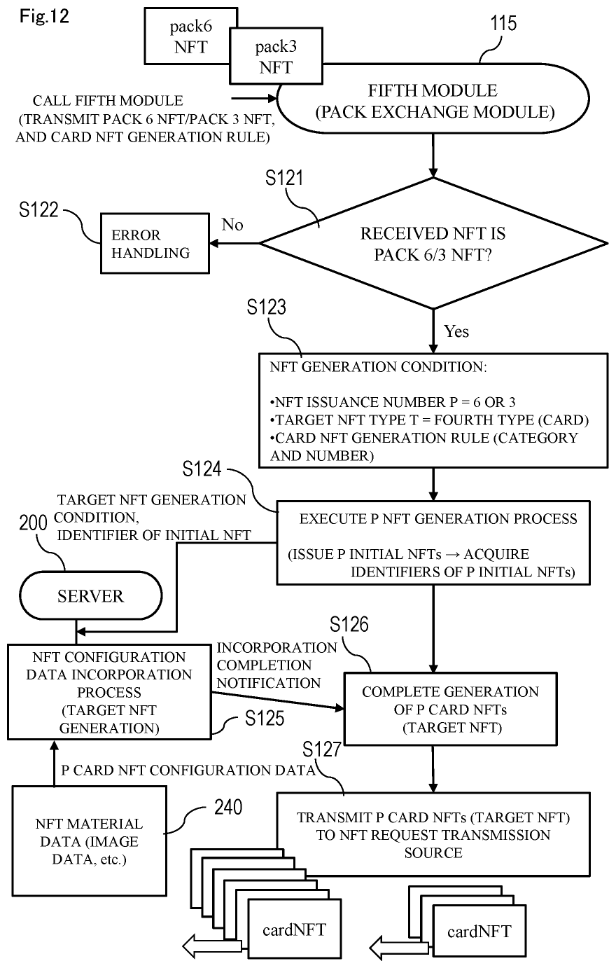

FIG. 12 shows the procedure of a process performed in the fifth module 115 (pack exchange module). First, the first smart contract 110 receives the fifth type request from the user terminal 300 or the server 350 being the user computer. An NFT (pack 6 NFT or pack 3 NFT) is also received together with the fifth type request. Transmission of the pack NFT to the fifth module 115 is accompanied by an operation of changing the owner of the pack NFT from the transmission source (user account) to the account of the smart contract 101 or the administrator of the smart contract 101. That is, the pack NFT is transferred from the user to the smart contract. The owner change of the NFT is recorded on the blockchain. The reception of the pack 6 NFT or the pack 3 NFT may be regarded as reception of the fifth type request.

In transmitting the fifth type request, information (combination information) indicating a combination of the categories C1, C2, C3, . . . of a plurality of card NFTs to be exchanged for the pack 6 NFT or the pack 3 NFT to be transmitted, is also transmitted.

In this embodiment, the server 200 includes the NFT generation rule 250 for determining the types of the respective card NFTs to be exchanged for the pack 6 NFT or the pack 3 NFT. The NFT generation rule 250 is, as an example, a combination of the categories C1, C2, C3, . . . of the respective card NFTs to be exchanged for the pack 6 NFT or the pack 3 NFT. A large number of patterns of combination of the categories C1, C2, C3 are set as the NFT generation rule 250. For example, an example of a pattern of combination for the pack 6 NFT consists of two card NFTs of category C1, two card NFTs of category C3, one card NFT of category C4, and one card NFT of category C6. An example of a pattern of combination for the pack 3 NFT consists of one card NFT of category C2, one card NFT of category C4, and one card NFT of category C5. A card NFT of a category having a low occurrence frequency in the NFT generation rule 250 can be treated as a rare card.

In this embodiment, as an example, when transmitting the fifth type request, (the application program of) the user terminal 300 or the server 350 accesses the server 200, and acquires the information (combination information) indicating a combination of the categories C1, C2, C3, . . . of the respective card NFTs to be exchanged for the pack 6 NFT or the pack 3 NFT. The acquired combination information is transmitted to the smart contract 101 together with the fifth type request, as information to be used for identifying the type of the target NFT.

Since the fifth type request is a call for the fifth module 115 in the second smart contract 120, operation of the fifth module 115 is started when the smart contract 101 has received the fifth type request. In the process in the fifth module 115, first, determination is made as to whether or not the type of the NFT received together with the fifth type request is a pack 6 NFT or a pack 3 NFT (step S121). This determination is performed by the NFT type determination module 117.

If the type of the received NFT is neither a pack 6 NFT nor a pack 3 NFT, error handling, such as notifying this fact to the user terminal 300, is performed (step S122). In this case, the process in the fifth module 115 is ended. The smart contract 101 may specify that the module to start operating is the fifth module 115 upon receiving the pack 6 NFT or the pack 3 NFT, and may allow the specified fifth module 115 to start operating. That is, the type of the received NFT (pack 6 NFT or pack 3 NFT) represents identification information, and the type of the NFT being the identification information determines the generation condition. In this case, steps S121, S122 can be omitted, and the process may be started from step S213.

If the type of the received NFT is a pack 6 NFT or a pack 3 NFT, generation condition for the target NFT is determined according to the type of the received NFT and the combination information (step S123). Here, if the received NFT is a pack 6 NFT, the NFT generation condition is determined such that target NFT issuance number P=6, and target NFT type T=fourth type (card). In addition, the category and number of target card NFTs to be generated are determined. The category and number of card NFTs to be generated are determined as indicated by the received combination information. This generation condition indicates that six card NFTs of the fourth type should be issued as the target NFT. That is, the pack 6 NFT is exchanged for six card NFTs. In addition, the generation condition indicates the categories and the number for each category of the six card NFTs to be generated. The categories and the number for each category are, for example, two card NFTs of category C1, two card NFTs of category C3, one card NFT of category C4, and one card NFTs of category C6, as described above.

If the received NFT is a pack 3 NFT, the NFT generation condition is determined such that target NFT issuance number P=3, and target NFT type T=fourth type (card). In addition, the category and number of card NFTs to be generated are determined. This generation condition indicates that three card NFTs of the fourth type should be issued as the target NFT. That is, the pack 3 NFT is exchanged for three card NFTs. In addition, the generation condition indicates the categories and the number for each category of the six card NFTs to be generated. The categories and the number for each category are, for example, one card NFT of category C2, one card NFT of category C4, and one card NFT of category C5, as described above.

The smart contract 120 may acquire the category and number of target card NFTs to be generated, from the server 200.

Subsequently, according to the generation condition, a process of issuing P (six or three) initial NFTs is executed, and the identifiers of the P initial NFTs are acquired (step S124). The initial NFT issuance process may be performed such that each of the issued the initial NFTs includes data indicating the generation condition such as “target NFT type T=fourth type (card)”, and the category.

Upon detecting the initial NFTs having been issued, the server 200 acquires the generation condition of the target NFT and the identifiers of the initial NFTs, and executes the NFT configuration data incorporation process, thereby generating card NFTs as the target NFT (step S125). The server 200 may acquire the generation condition of each initial NFT, such as “target NFT type T” and “category”, by referring to the records of the initial NFTs on the blockchain. In the NFT configuration data incorporation process, according to “target NFT type T=fourth type (card)” and “category”, configuration data for the card NFTs are selected from among a plurality of NFT material data 240. The plurality of material data 240 included in the database 230 include material data for the card NFTs of the fourth type (card). The system 10 may select the material data to be the configuration data, based on the type T identified based on the received identification information. The configuration data for the card NFTs include, for example, image data indicating the categories C1, C2, C3, . . . of the card NFTs, character data indicating the names of the categories of the card NFTs, image data D1, D2, D3, . . . according to the subjects of the card NFTs, and the like. The names of the categories indicate, for example, ranks such as platinum, gold, and silver.

The image data indicating the categories C1, C2, C3, . . . of the card NFTs, and the character data indicating the names of the categories of the card NFTs are selected from among the plurality of NFT material data 240, based on “category” indicated by the generation condition. The image data D1, D2, D3, . . . according to the subjects of the card NFTs are, for example, determined at random by the server 200 from among material data to be candidates for the image data according to the subjects of the card NFTs. For example, if the subject of a card NFT is a player of a sports team, image data of a plurality of players who belong to the sports team are registered as candidates for the image data D1, D2, D3 corresponding to the subject of the card NFT. The server 200 determines image data according to the subject of the card NFT at random from among the candidates. The subject of the card NFT may be determined according to the type of pack 6 or pack 3. For example, a pack 6 NFT for team A to be exchanged for a card NFT of a player of team A, and a pack 6 NFT for team B to be exchanged for a card NFT of a player of team B, may exist. In this case, when receiving the pack 6 NFT for team A, the system 10 may generate a card NFT of a certain player who belongs to the team A, by using image data selected from among a plurality of image data of players of the team A. Meanwhile, when receiving a pack 6 NFT for team B, the system 10 may generate a card NFT of a certain player who belongs to the team B, by using image data selected from among a plurality of image data of players of the team B.

In this embodiment, in addition to the image data according to the subjects, image data according to the categories are also given to the card NFTs. Therefore, a great variety of card NFTs are available, which enhances the pleasure of collection. For example, among a plurality of card NFTs that are given image data of the same player, a card NFT that is given an image of category C1 and a card NFT that is given an image of category C2 may be recognized as different types of card NFTs. For example, among a plurality of card NFTs having the same image data of a certain player, a card NFT having characters indicating “platinum” as category C1 and an image regarding “platinum”, and a card NFT having characters indicating “gold” as category C2 and an image regarding “gold”, may be recognized as different types of card NFTs. Thus, the card NFTs having the image data of the same player may have different values because they belong to the different categories.

Thus, configuration data for P (six or three) NFTs are generated. Then, the configuration data for the card NFTs are incorporated in the P initial NFTs, thereby completing the P (six or three) card NFTs. The configuration data may be incorporated when the initial NFTs are issued. When the P card NFTs have been completed, the server 200 transmits a completion notification to the smart contract 101. Upon receiving the incorporation completion notification, the smart contract 101 recognizes that generation of the P card NFTs has been completed (step S126), and transmits the card NFTs to the user account that is the transmission source of the pack NFT (step S127). The configuration data for each card NFT may include identification information, such as a serial number of the card NFT, which distinguishes the card NFT from the other card NFTs and makes the card NFT unique. Such identification information for making a certain card NFT unique may enhance the scarcity value of the card NFT even if the card NFT has common material data that can also be used for the other card NFTs.

As described above, the user can obtain the P card NFTs in exchange for giving the box NFT. That is, the user can enjoy an experience similar to opening a pack containing six or three cards. The system 10 according to the embodiment generates the card NFTs after transfer of the pack NFT, and therefore, need not hold the card NFTs to be given to the user, before transfer of the pack NFT. In particular, in the system 10 according to the embodiment, many types of card NFTs, i.e., M×N (the number M of categories×N pieces of image data according to subject) card NFTs, may exist, but it is not necessary to generate such many types of card NFTs in advance, and cause the system 10 to hold the card NFTs.

Moreover, in the system 10 according to the embodiment, it is not determined in advance what kinds of card NFTs the pack 6 NFT or the pack 3 NFT is exchanged for. Therefore, the work of assigning in advance card NFTs for exchange, to each of many pack 6 NFTs or pack 3 NFTs to be sold, is not necessary. It may be identified that the NFTs to be generated by the system 10 are card NFTs, by the fact that the type of the NFT transmitted to the smart contract 101 is a pack 6 NFT or a pack 3 NFT. In addition, the smart contract 101 of this embodiment can determine what kind of target non-fungible token should be generated, based on the number or type of received request transmission tokens, thereby generating an appropriate target non-fungible token.

As described above, in the smart contract 101 according to the embodiment, what kind of target NFT should be generated and transmitted is set depending on what has been received as a request transmission token. In this embodiment, the trigger for operation start (activation) of the smart contract 101 is the user having transmitted something to the smart contract 101. More specifically, the trigger for operation start (activation) of the smart contract 101 is the user having transmitted some token (request transmission token) to the smart contract 101.

### 2.2 Second Embodiment: Ticket NFT Generation System

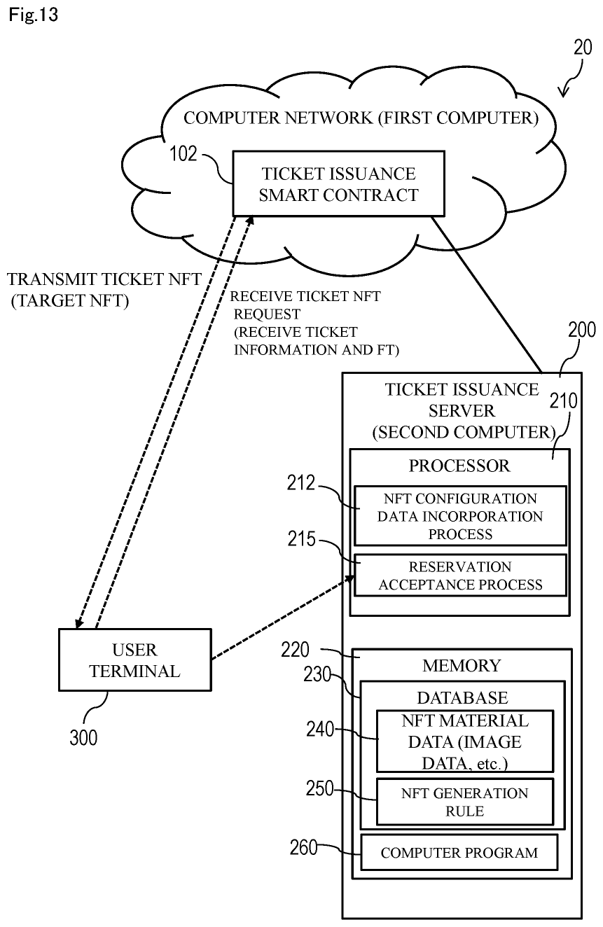

FIG. 13 shows an example of a system 20 according to a second embodiment. In the second embodiment, contents that are not particularly described are the same as those of the system 10 according to the first embodiment.

The system 20 according to the second embodiment includes: a smart contract 102 implemented on a computer network system such as a blockchain; and a server 200. The system 20 according to the second embodiment generates digital ticket NFTs in order to provide sales or issuance services of the digital ticket NFTs. The system 20 is communicable, via the network, with a terminal 300 (user terminal) possessed by a user who desires to purchase or issuance of a digital ticket NFT.

The smart contract 102 according to the second embodiment is configured to execute a ticket NFT generation process. The server 200 according to the second embodiment is configured to execute an NFT configuration data incorporation process 212. In addition, the server 200 according to the second embodiment may execute a reservation acceptance process 215 for accepting a reservation from the user for issuance of a ticket NFT.

A digital ticket NFT provided by the system 20 according to the second embodiment is a ticket that is non-fungible tokenized. The digital ticket NFT is displayed on a computer screen. Hereinafter, the digital ticket NFT is referred to as a ticket NFT. The ticket NFT can also be transacted with any third party.

Examples of the ticket include: tickets for participating in events such as concerts, live performances, plays, movies, and seminars; tickets for admission to facilities such as art museums and other museums; and tickets for using transportation such as trains, planes, and buses. These tickets are exchange tickets or gift certificates for receiving provision of goods and services. Examples of the ticket may include discount coupons for purchasing goods and services.

The ticket NFT according to the embodiment is configured such that configuration data, such as image data or character data indicating that the NFT is a ticket, is incorporated in the NFT issued on the blockchain. The NFT incorporating the configuration data includes, for example, the configuration data itself or a URI that directly or indirectly indicates the configuration data. The URI may directly or indirectly indicate the configuration data. For example, a ticket NFT for an event incorporates image data or character data for the event. The configuration data incorporated in the ticket NFT may vary for each purpose of the ticket NFT (e.g., specific event). Therefore, there are a plurality of types of ticket NFTs.

The system 20 according to the second embodiment can generate a ticket NFT of a type corresponding to the type, purpose, etc., of the event, and provide the user with the ticket NFT. As shown in FIG. 13, the system 20 according to the second embodiment receives a ticket NFT request (NFT request) from the user terminal 300 or the like being a user computer, and transmits, as a target NFT, a ticket NFT to the account of the user. Here, the ticket NFT request is performed as a call for the ticket issuance smart contract 102. Upon being called, the ticket issuance smart contract 102 executes the ticket NFT generation process.

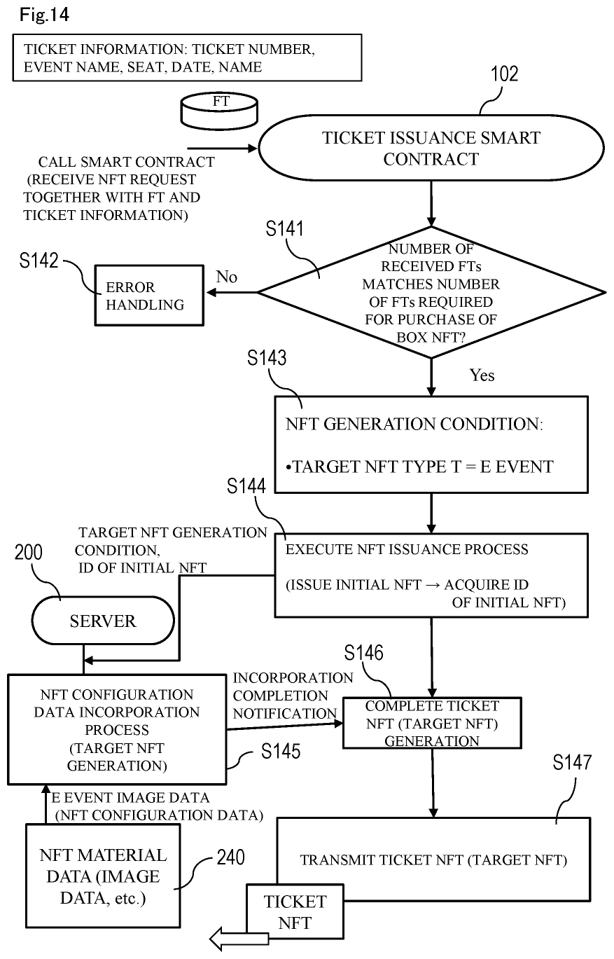

FIG. 14 shows the procedure of the ticket NFT generation process in the ticket issuance smart contract 102. First, the smart contract 102 receives an NFT request from the user terminal 300 or the like being a user computer. The smart contract 102 may receive the NFT request from the server being a user computer. The NFT request is a request for issuance of a ticket NFT. For the NFT request, an FT equivalent to a ticket NFT purchase price is received. Transmission of the FT is accompanied by an operation of changing the owner of the FT from the transmission source (user account) to the account of the smart contract 101 or the administrator of the smart contract 101. That is, the FT equivalent to the ticket NFT purchase price is paid by the user. The owner change is recorded on the blockchain. Reception of the ticket NFT request may be performed as reception of an NFT (ticket exchange NFT) to be exchanged for the ticket NFT. The ticket exchange NFT may have ticket information described later. The smart contract 102 can generate the ticket NFT by using the ticket information possessed by the ticket exchange NFT.

The smart contract 102 also receives the ticket information together with the NFT request. The ticket information includes, for example, ticket number, event name, information on the reserved seat, date of event, name, etc. The ticket information is generated in the reservation acceptance process 215 by the server 200, for example, and the ticket information generated upon establishment of reservation acceptance is transmitted to a ticket reservation application program of the user terminal. The ticket reservation application program can cause the user terminal 300 (computer) or the like being a user computer to execute a process of transmitting the NFT request to the smart contract 102 together with the received ticket information. The ticket information may be used as identification information for identifying the type of the ticket NFT being the target NFT. The type of the ticket NFT to be generated may be represented by the number or type of FTs or NFTs (ticket exchange NFTs) that are the request transmission tokens received by the smart contract 102.

Upon receiving the NFT request, the smart contract 102 determines whether or not the number of the received FTs matches the number of FTs required for purchase of the requested ticket NFT (step S141). This determination is performed by the number-of-FTs determination module 116. The number of FTs required for purchase of the ticket NFT has been notified to the user terminal in advance.

If the number of the received FTs does not match the number of FTs required for purchase of the ticket NFT, error handling, such as notifying this fact to the user terminal 300, is performed (step S142). In this case, the ticket issuance process is ended.

If the number of the received FTs matches the number of FTs required for purchase of the ticket NFT, generation condition for the target NFT is determined (step S143). Here, the generation condition is determined such that target NFT issuance number P=1, and target NFT type T=E event, based on the received ticket information. This generation condition indicates that one ticket NFT for the E event should be issued as the target NFT. The generation condition may be determined according to the number or type of FTs or NFTs (ticket exchange NFTs) as the request transmission tokens received by the smart contract 102.

Subsequently, according to the generation condition, a process of issuing P (one) initial NFT is executed, and the identifier of the initial NFT is acquired (step S144). The initial NFT issuance process may be performed such that the issued initial NFT includes data indicating the generation condition such as “target NFT type T=E event”.

Upon detecting the initial NFT having been issued, the server 200 acquires the generation condition for the target NFT and the identifier of the initial NFT, and executes the NFT configuration data incorporation process, thereby generating a ticket NFT as the target NFT (step S145). The server 200 may acquire the generation condition such as “initial NFT type T” by referring to the record of initial NFTs on the blockchain.

In the NFT configuration data incorporation process, according to the target NFT type T=the E event, configuration data for the E event (e.g., image data for the E event, and character data indicating the name, ticket number, seat, date, etc., of the E event) is selected from among a plurality of NFT material data 240. The plurality of material data 240 included in the database 230 include a plurality of pieces of material data corresponding to a plurality of types of events. That is, the database 230 includes the material data for the E event. Based on the type T identified based on the received identification information, the system 20 may select material data to be the configuration data, from among the plurality of material data. Here, since the ticket information (E event) received as the identification information indicates any of the plurality of material data, the system 20 can select data to be incorporated in the NFT from among the plurality of material data, based on the identification information (E event). Then, the configuration data for the E event is incorporated in the initial NFT, thereby completing the ticket NFT for the E event. The name or the like of the E event is common material data that may be used for generation of other configuration data, while the ticket number or the like is information that makes the configuration data unique. The configuration data may be incorporated when the initial NFT is issued. The system 20 has a private key for generating a ticket NFT, and generates the ticket NFT by using the private key. Such a private key for NFT generation allows the system 20 to generate the ticket NFT without using the private key of the user. When the ticket NFT has been completed, the server 200 transmits a completion notification to the smart contract 102. Upon receiving the incorporation completion notification, the smart contract 102 recognizes that generation of the ticket NFT has been completed (step S146), and transmits the ticket NFT to the user account that is the FT transmission source (step S147).

As described above, the user can obtain the ticket NFT in exchange for paying the FTs. The system 20 according to the embodiment generates the ticket NFT after payment of the FTs, and therefore need not hold various types of ticket NFTs to be given to the user, before payment of the FTs. The ticket NFT request need not be accompanied by payment for the ticket NFT purchase price.

### 2.3 Third Embodiment: Certificate NFT Generation System

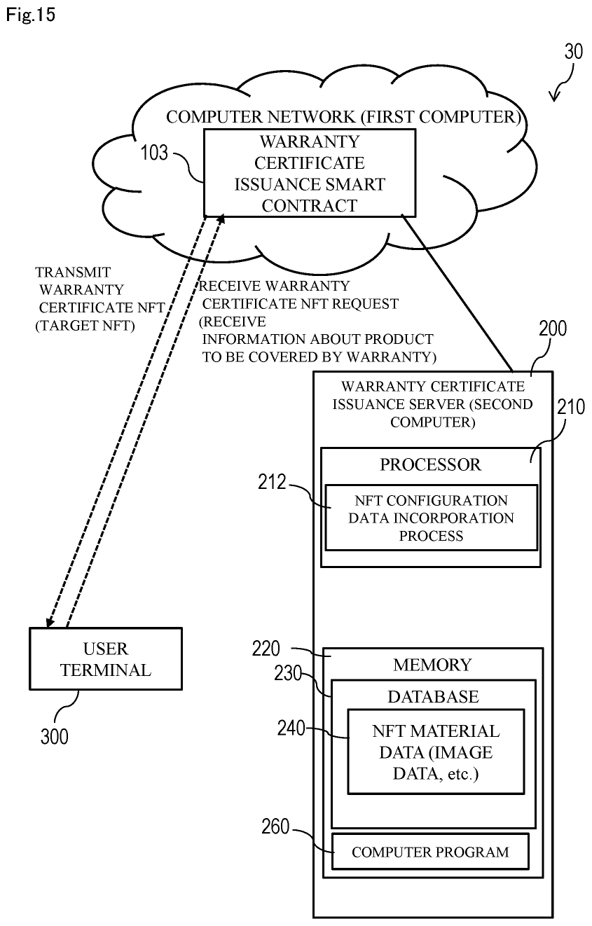

FIG. 15 shows an example of a system 30 according to a third embodiment. In the third embodiment, contents that are not particularly described are the same as those of the system 10 according to the first embodiment and the system 20 according to the second embodiment.

The system 30 according to the third embodiment includes: a smart contract 103 implemented on a computer network system such as a blockchain; and a server 200. The system 30 according to the third embodiment generates a certificate NFT such as a warranty certificate NFT to provide the certificate NFT. The system 30 is communicable, via the network, with a user computer such as a terminal 300 (user terminal) possessed by the user who desires issuance of a certificate NFT.

The smart contract 103 according to the third embodiment is configured to execute a certificate NFT generation process. The server 200 according to the second embodiment is configured to execute an NFT configuration data incorporation process 212.

A certificate NFT provided by the system 30 according to the third embodiment is a certificate such as a warranty certificate that is non-fungible tokenized. The certificate NFT is displayed on a computer screen. The certificate NFT can be transacted with any third party.

The warranty certificate is a document that certifies any warranty regarding, for example, daily necessities, jewelry, electrical products, electronic products, mechanical products, other articles, services, or rights-related subjects (rights, obligations, responsibilities). The certificate is a document that certifies the above warranty or other facts.

The warranty certificate NFT according to the embodiment is configured such that configuration data, such as image data or character data indicating that the NFT is a warranty certificate, is incorporated in the NFT issued on the blockchain. The NFT incorporating the configuration data includes, for example, the configuration data itself or a URI indicating the configuration data. The URI may directly or indirectly indicate the configuration data. For example, if a warranty certificate NFT serves as a warranty certificate that warrants repair or the like regarding imperfection, defect, or malfunction of a product such as a home appliance, image data of the home appliance and character data indicating the details of the warranty are incorporated in the NFT. The configuration data incorporated in the certificate NFT may vary for each type of the certificate. Therefore, there are a plurality of types of warranty certificate NFTs.

The system 30 according to the third embodiment can generate a warranty certificate NFT according to the type of the product to be covered by a warranty, and provide the user with the warranty certificate NFT. As shown in FIG. 15, the system 30 according to the third embodiment receives a certificate NFT request from the user terminal 300, generates a warranty certificate NFT as a target NFT, and transmits the certificate NFT to the user terminal 300 (user account). A warranty period of the product to be covered by a warranty may be calculated from the date of purchase of the product (warranty starting date), or may be calculated from the date of issuance of the warranty certificate NFT on the blockchain (warranty starting date).

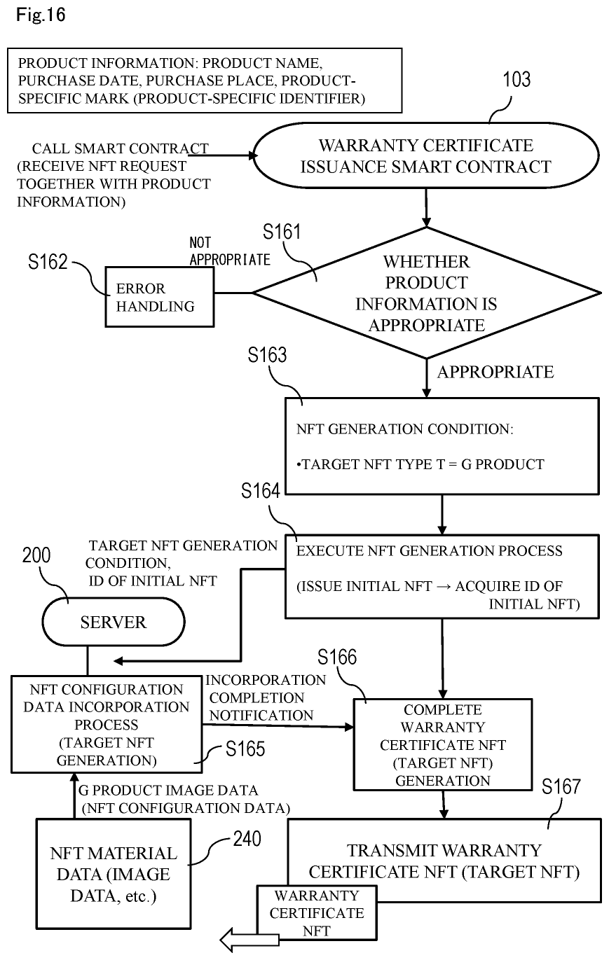

FIG. 16 shows the procedure of a warranty certificate issuance process in a warranty certificate issuance smart contract 103. First, the smart contract 103 receives an NFT request from the user terminal 300. Here, the NFT request is a request for issuance of a warranty certificate NFT. The smart contract 103 also receives product information about a product to be covered by a warranty, together with the NFT request. The product information includes at least one of name of the product, purchase date of the product, purchase place of the product, product-specific mark (product-specific identifier), and the like. For example, the product information is preferably recorded on a machine-readable code (e.g., two-dimensional code) that is given to the product, or a document or any other object attached to the product. For example, the user terminal 300 can acquire the product information by reading the two-dimensional code or the like with a camera (code reader) of the user terminal 300. The product information may be electronic data that is stored in a computer (e.g., the server 200) on the network, and is represented by a URI (Uniform Resource Identifier) indicated by a machine-readable code. In this case, the user terminal 300 can acquire the product information by reading the code with the camera of the user terminal 300, and accessing the URI indicated by the code through the network.

The product information is used for identifying the type of the warranty certificate NFT as the target NFT.

Upon receiving the NFT request, the smart contract 103 determines whether or not the received product information is appropriate (step S161). This determination is, for example, determination as to whether or not the product-specific mark actually exists.

If the product information is not appropriate, error handling, such as notifying this fact to the user terminal 300, is performed (step S162). In this case, the warranty certificate issuance process is ended.

If the product information is appropriate, generation condition for the target NFT is determined (step S163). Here, the generation condition is determined such that target NFT issuance number P=1, and target NFT type T=G product, based on the received product information. This generation condition indicates that one warranty certificate NFT for the G product should be issued as the target NFT.

Subsequently, according to the generation condition, a process of issuing P (one) initial NFT is executed, and the identifier of the initial NFT is acquired (step S164). The initial NFT issuance process may be performed such that the issued initial NFT includes data indicating the generation condition such as “target NFT type T=G product”.

Upon detecting the initial NFT having been issued, the server 200 acquires the generation condition for the target NFT and the identifier of the initial NFT, and executes the NFT configuration data incorporation process, thereby generating a warranty certificate NFT as the target NFT (step S165). The server 200 may acquire the generation condition such as “initial NFT type T” by referring to the record of the initial NFT on the blockchain.

In the NFT configuration data incorporation process, according to the target NFT type T=the G product, configuration data for the G product (e.g., image data for the G product, name of the G product, purchase date of the G product, purchase place of the G product, product-specific mark (product-specific identifier), and character data indicating the warranty period) is selected from among a plurality of NFT material data 240. The plurality of material data 240 included in the database 230 include a plurality of pieces of material data corresponding to a plurality of types of products. That is, the database 230 includes the material data for the G product. Based on the type T identified based on the received identification information, the system 30 may select material data to be the configuration data, from among the plurality of material data. Here, since the product information (G product) received as the identification information indicates any of the plurality of material data, the system 30 can select data to be incorporated in the NFT from among the plurality of material data, based on the identification information (G product). Then, the configuration data for the G product is incorporated in the initial NFT, thereby completing the warranty certificate NFT for the G product. The configuration data may be incorporated when the initial NFT is issued. The system 30 has a private key for generating a warranty certificate NFT, and generates the warranty certificate NFT by using the private key. Such a private key for NFT generation allows the system 10 to generate the warranty certificate NFT without using the private key of the user. When the warranty certificate NFT has been completed, the server 200 transmits a completion notification to the smart contract 103. Upon receiving the incorporation completion notification, the smart contract 103 recognizes that generation of the warranty certificate NFT has been completed (step S166), and transmits the warranty certificate NFT to the user account that is the transmission source of the NFT request (step S167). The name or the like of the G product is common material data that may be used for generation of other configuration data, while the product-specific mark or the like is information that makes the configuration data unique.

As described above, the user can obtain the warranty certificate NFT. The system 30 according to the embodiment generates the warranty certificate NFT after reception of the NFT request, and therefore need not prepare the warranty certificate NFT before the NFT request (e.g., during a period from production to sale of the product), whereby time and labor for generating a warranty certificate NFT of a product that is not sold, can be saved.

### 2.4 Fourth Embodiment: Storage and Reference of Configuration Data

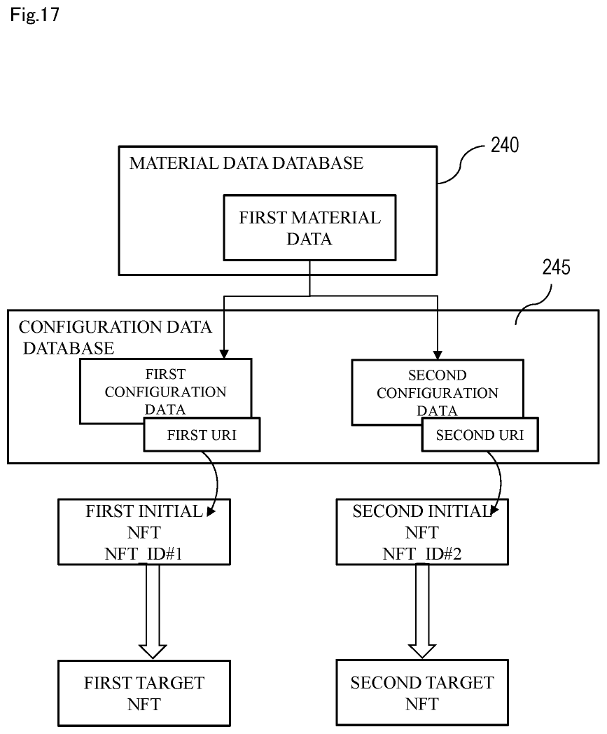

FIG. 17 shows a method, for storing and referring to configuration data, which may be applied to each of the embodiments described above and below. A plurality of material data are stored in a material data database 240. For example, it is assumed that the plurality of material data include first material data, and the first material data is image data of a certain entertainer. The first material data is duplicated and stored as first configuration data in a configuration data database 245 of the server 200. That is, the first configuration data is duplicate data of the first material data. The first configuration data exists as data different from the first material data by having a file name different from the first material data, or being stored in a location different from the first material data. The first configuration data in the network such as the Internet is represented by a first URI (first Uniform Resource Identifier). The first configuration data is incorporated in a first initial NFT, thereby generating a first target NFT.

Also, the first material data is duplicated and stored as second configuration data in the configuration data database 245 of the server 200. That is, the second configuration data is duplicate data of the first material data. The second configuration data exists as data different from the first material data and the first configuration data by having a file name different from the first material data and the first configuration data, or being stored in a location different from the first material data and the first configuration data. The second configuration data in the network such as the Internet is represented by a second URI (second Uniform Resource Identifier) different from the first URI. The second configuration data is incorporated in a second initial NFT different from the first initial NFT, thereby generating a first target NFT.

Therefore, the first target NFT and the second target NFT have, as the configuration data, the same image data of the same entertainer. That is, the first configuration data possessed by the first target NFT is generated from the first material data that has also been used for generation of the second configuration data possessed by the second target NFT. However, the first configuration data and the second configuration data stored in the configuration data database 245 are separate pieces of data. That is, the first configuration data is unique data for the first target NFT, and is not incorporated in NFTs other than the first target NFT. Likewise, the second configuration data is unique data for the second target NFT, and is not incorporated in NFTs other than the second target NFT. This makes each of the first target NFT and the second target NFT the one and only. Therefore, for example, by adding an image of a signature of the entertainer to the first target NFT, the first target NFT can be made different in value from the second target NFT. Also, the first target NFT can be made different in value from the second target NFT by the owner history of the first target NFT.

Incorporating the first configuration data into the first initial NFT to be the first target NFT may be, for example, writing the first URI or an identifier associated with the first URI into the first initial NFT. The first URI indicates the first configuration data that is the duplicate data. The first target NFT having the first URI allows the server 200 to be accessed through the network using the first URI, and to display the first configuration data on, for example, the terminal device of the owner of the first target NFT. The identifier associated with the first URI only needs to be information that allows the server 200 to recognize the first URI, for example. The first target NFT having the identifier associated with the first URI allows the server 200 to be accessed through the network using the identifier associated with the first URI, to specify the first URI from the identifier, and to display the first configuration data indicated by the first URI on, for example, the terminal device of the owner of the first target NFT. The same applies to the second target NFT.

Incorporating the first configuration data into the first initial NFT to be the first target NFT may be setting, in the server 200, a correspondence relationship between the identifier (NFT-ID) of the first target NFT (first initial NFT) and the first URI. This allows the server 200 to be accessed through the network using the identifier (NFT-ID) of the first target NFT, to specify the first URI from the identifier (NFT-ID) of the first target NFT, and to display the first configuration data indicated by the first URI on, for example, the terminal device of the owner of the first target NFT. The same applies to the second NFT.

The database 246 may be constituted by, as an example, an IPFS (InterPlanetary File System). The IPFS is an example of a P2P (Peer to Peer) distributed file system. In the IPFS, stored data (content) is designated by a URI using a hash value obtained from the data. This URI is an identifier indicating configuration data, and is also called a content identifier. In order to incorporate configuration data into an NFT, for example, the URI designating the configuration data (content) stored in the IPFS may be written in the NFT. That is, the NFT may have the URI indicating the configuration data stored in the IPFS. The NFT may include configuration data (content), metadata including a URI indicating the configuration data (content), and index data including a URI indicating the metadata. The index data may include an identifier (NFT-ID; token identifier) of the NFT, and an owner (owner blockchain address) of the NFT. As an example, the index data may be recorded on the blockchain, and the configuration data and the metadata may be recorded in the IPFS. The aforementioned initial NFT may have the index data, and may not necessarily have the metadata and the configuration data. The metadata and the configuration data may be added to the NFT through a configuration data incorporation process. The index data recorded on the blockchain may have a URI that directly indicates the configuration data stored outside the blockchain, e.g., stored in the IPFS, or may have a URI that indirectly indicates the configuration data, such as the URI indicating the metadata including the URI that directly indicates the configuration data. Thus, not all of the NFT needs to be recorded on the blockchain, and at least some data, such as the index data, may be recorded on the blockchain.

### 2.5 Fifth Embodiment

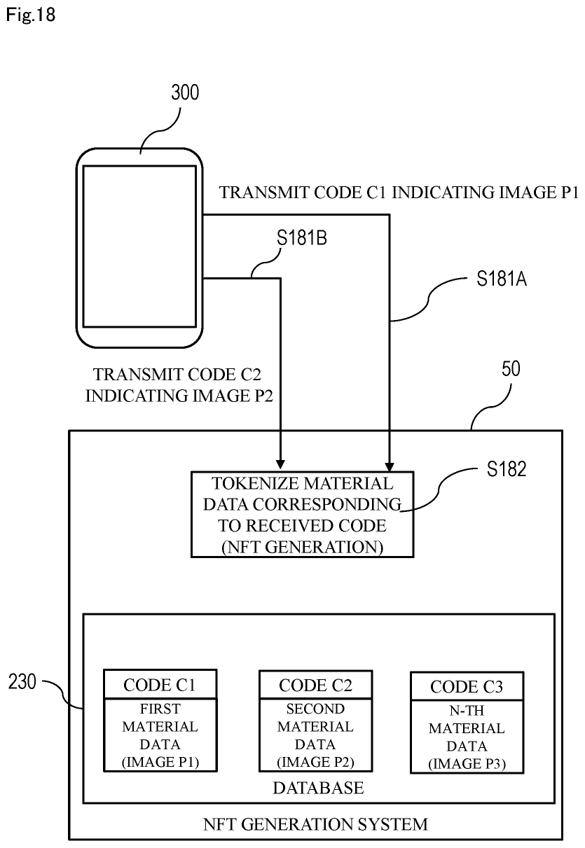

FIG. 18 shows an example of a system 50 according to a fifth embodiment. In the fifth embodiment, contents that are not particularly described are the same as those of the systems 10, 20, 30 according to the aforementioned embodiments.

The system 50 may receive an NFT request having a code C1 indicating an image P1 from a computer such as the terminal 300 (step S181A). The code C1 may be identification information that allows the system 50 to identify the type of the target NFT. The database 230 included in the system 50 includes a plurality of material data P1, P2, P3, and the material data P1, P2, P3 are associated with codes C1, C2, C3, respectively. The code C1 with which the material data P1, P2, P3 are associated indicates the corresponding material data P1, P2, P3. The system 50 selects the first material data P1 corresponding to the code C1 received in step S181A, and generates a target NFT by using the selected first material data P1 (step S182). The target NFT generated by using the first material data P1 may be an NFT of a type “having image P1”. The target NFT generated by using the first material data P1 may include, for example, the identifier (e.g., URI) of the first material data, or the identifier (e.g., URI) of the duplicate data of the first material data.

The system 50 may receive an NFT request having the code C2 indicating the image P2 from a computer such as the terminal 300 (step S181B). The code C2 may be identification information that allows the system 50 to identify the type of the target NFT. The system 50 selects the second material data P2 corresponding to the code C2 received in step S181B, and generates a target NFT by using the selected second material data P2 (step S182). The target NFT generated by using the second material data P2 may be an NFT of a type “having image P2”. The target NFT generated by using the second material data P2 may include, for example, the identifier (e.g., URI) of the second material data, or the identifier (e.g., URI) of the duplicate data of the second material data.

Since the system 50 includes the material data such as the images used for NFT generation, the system 50 can generate an NFT without material data for NFT generation being acquired from an external computer such as the terminal 300. However, the system 50 may acquire a part of the material data for NFT generation from the external computer. The system 50 can generate an NFT by using at least the material data P1, P2, P3 that the system 50 has possessed before reception of the NFT request (step S181A, S181B).

### 2.6 Sixth Embodiment

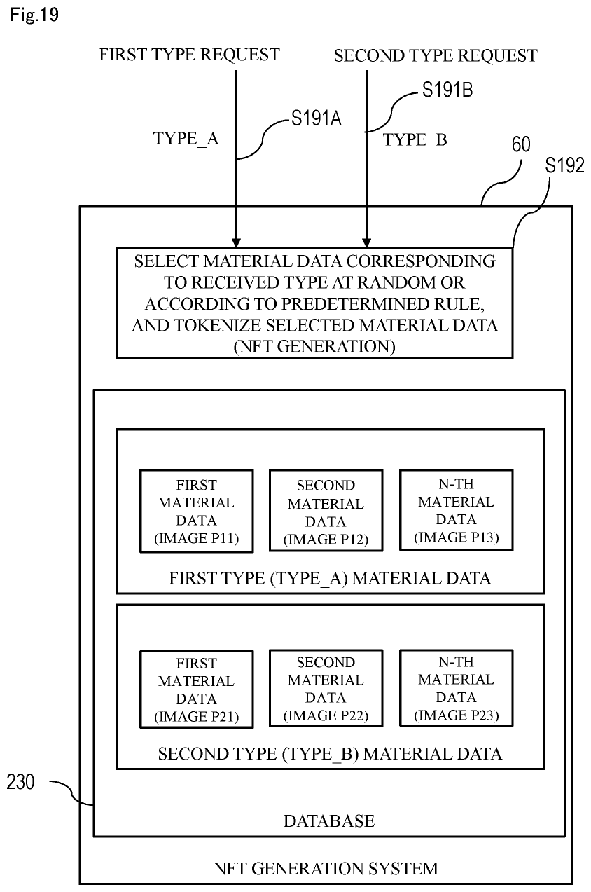

FIG. 19 shows an example of a system 60 according to a sixth embodiment. In the sixth embodiment, contents that are not particularly described are the same as those of the systems 10, 20, 30, 50 according to the aforementioned embodiments.

The system 60 may receive an NFT request from a computer such as the terminal 300 (not shown) (step S191). The NFT request includes data indicating the type of a target NFT to be generated. The data indicating the type may be identification information that allows the system 50 to identify the type of the target NFT. The database 230 included in the system 60 includes material data corresponding to a plurality of types. For example, the database 230 shown in FIG. 19 includes a plurality of material data P11, P12, P13 for the first type (TYPE_A), and a plurality of material data P21, P22, P23 for the second type (TYPE_B).

Upon receiving an NFT request having the data indicating the first type (TYPE_A) as identification information (step S191A), the system 60 identifies that the type is the first type (TYPE_A), based on the NFT request. Furthermore, the system 60 selects material data (e.g., image P12) to be used for generation of the target NFT from among the plurality of material data P11, P12, P13 corresponding to the identified type. The material data to be used for generation of the target NFT is selected at random or according to a predetermined rule from among the plurality of material data P11, P12, P13 corresponding to the identified type (TYPE_A). The system 60 generates the target NFT by using the selected material data (step S192). The generated target NFT may be an NFT whose type is TYPE_A.

Upon receiving an NFT request having the data indicating the second type (TYPE_B) as identification information (step S191B), the system 60 identifies that the type is the second type (TYPE_B), based on the NFT request. Furthermore, the system 60 selects material data (e.g., image P23) to be used for generation of a target NFT from among the plurality of material data P21, P22, P23 corresponding to the identified type. The material data to be used for generation of a target NFT is selected at random or according to a predetermined rule from among the plurality of material data P21, P22, P23 corresponding to the identified type (TYPE_B). The system 60 generates a target NFT by using the selected material data (step S192). The generated target NFT may be an NFT whose type is TYPE_B.

### 2.7 Seventh Embodiment

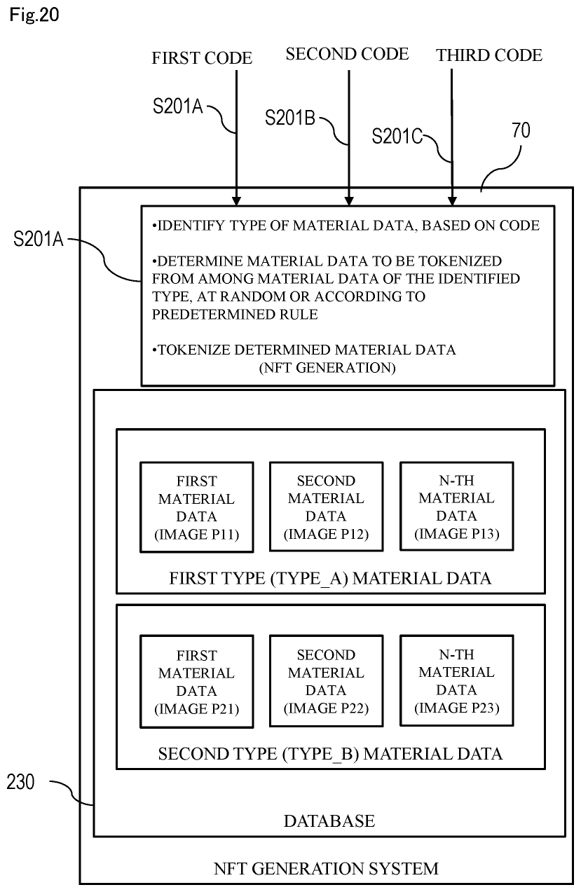

FIG. 20 shows a system 70 according to a seventh embodiment. In the seventh embodiment, contents that are not particularly described are the same as those of the systems 10, 20, 30, 50, 60 according to the aforementioned embodiments.

The system 70 may receive an NFT request from the user terminal 300 (not shown) (step S191). The NFT request may include a code. The code is data that is given or notified to a user who desires to acquire the NFT. The code may be qualification information for the user to acquire the NFT. For example, a first user can receive the NFT by transmitting, to the system 70, a first code having been given or notified to the first user. Meanwhile, a second user can receive the NFT by transmitting, to the system 70, a second code having been given or notified to the second user, and a third user can receive the NFT by transmitting, to the system 70, a third code having been given or notified to the third user.

The code may be identification information that allows the system 70 to identify the type of the target NFT. The code may be data that allows the system 70 to identify the type of the material data. The database 230 included in the system 70 includes material data corresponding to a plurality of types. For example, the database 230 shown in FIG. 20 includes a plurality of material data P11, P12, P13 for the first type (TYPE_A), and a plurality of material data P21, P22, P23 for the second type (TYPE_B).

The system 70 may have a code list (not shown) showing a list of codes that the system 70 can possibly receive. Each of the codes included in the code list is associated with a type. As an example, in the system 70, the first code and the second code are associated with the first type (TYPE_A), and the third code is associated with the second type (TYPE_B). In this case, when the system 70 has received an NFT request having the first code (step S201A) or has received an NFT request having the second code (step S201B), the system 70 identifies, based on the received code, that the type of the material data is the first type (TYPE_A). The system 70 selects material data (e.g., image P11) to be used for generation of the target NFT from among the material data P11, P12, P13 for the first type (TYPE_A). The material data to be used for generation of the target NFT is selected at random or according to a predetermined rule from among the plurality of material data P11, P12, P13 corresponding to the identified type (TYPE_A). The system 70 generates the target NFT by using the selected material data (step S202). The generated target NFT may be an NFT whose type is TYPE_A.

Upon receiving an NFT request having the third code (step S201C), the system 70 identifies that the type of the material data is the second type (TYPE_B), based on the received code. The system 70 selects material data (e.g., image P22) to be used for generation of the target NFT from among the material data P21, P22, P23 for the second type (TYPE_B). The material data to be used for generation of the target NFT is selected at random or according to a predetermined rule from among the plurality of material data P21, P22, P23 corresponding to the identified type (TYPE_B). The system 70 generates the target NFT by using the selected material data (step S202). The generated target NFT may be an NFT whose type is TYPE_B.

If the NFT request does not include identification information such as a code, each of the systems 10, 20, 30, 50, 60, 70, upon receiving an NFT request, can select material data to be used for generation of the target NFT at random or according to a predetermined rule from among a plurality of identification data.

### 2.7 Seventh Embodiment: Use of Private Key

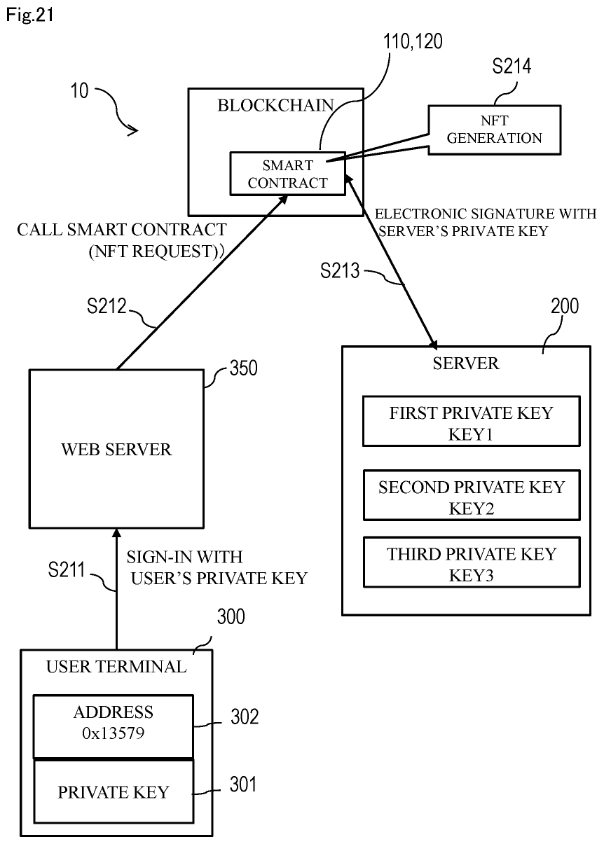

FIG. 21 shows a technique regarding handling of a private key. The technique shown in FIG. 21 is adaptable to the system 10 of the first embodiment and the systems of the other embodiments. Upon receiving an NFT request (step S212), the smart contract 110, 120 affixes an electronic signature to a transaction for NFT generation, by using any one of a plurality of private keys Key1, Key2, Key3 possessed by the server 200 of the smart contract 110, 120 (step S213). The transaction with the electronic signature is recorded on the blockchain. Thus, an NFT is generated (step S214). Since the third party, who can refer to the blockchain, can also refer to the smart contract 110, 120 on the blockchain, if the smart contract 110, 120 possesses such a private key, the private key is in danger of being known by the third party. Since the private keys Key1, Key2, Key3 for NFT generation are possessed by the external computer such as the server 200, these private keys can be safely stored.

When NFT generation (step S214) is requested, the smart contract 110, 120 notifies the server 200 of this request, and acquires a private key for an electronic signature. The server 200 appropriately selects one private key to be used for NFT generation from among the plurality of private keys Key1, Key2, Key3, and provides the smart contract 110, 120 with the selected private key. The smart contract 110, 120 affixes an electronic signature by using the acquired private key. That is, although the system 10 generates an NFT through the smart contract 110, 120, the system 10 uses the private key stored in the computer 200 outside the smart contract 110, 120 to generate the NFT. The server 200 may affix the electronic signature.

In FIG. 21, the smart contract 110, 120 may receive an NFT request from a Web server 350 (step S212). The Web server 350 is an example of the user computer shown in FIG. 1. The Web server 350 may provide the user terminal 300 with a user interface. The user interface is, for example, a website that displays an image to be non-fungible tokenized, and receives a user operation for NFT acquisition. The user may sign in to the website by using the user terminal 300 (step S211). A private key 301 of the user is used for the sign-in. The user has a blockchain address 302 corresponding to the private key 301. In FIG. 21, as an example, the blockchain address 302 of the user is 0x13579. The blockchain address 302 may be generated from the private key 301.

The user, who has signed in to the website by using the private key 301, becomes able to operate the blockchain through the website. That is, for the user who has signed in to the website, the Web server 350 can affix an electronic signature to a transaction to be recorded on the blockchain, by using the private key 301. The user terminal 300 may affix the electronic signature.

The operation on the blockchain by the Web server 350 is, for example, a call for the smart contract 1110, 120 (step S212). Here, a call for the smart contract may also be transmission of an NFT request to the smart contract.

In calling the smart contract 110, 120, the blockchain address 302 of the user is transmitted to the smart contract 110, 120. The smart contract 302 transmits the generated NFT to the received blockchain address 302. Thus, the smart contract 110, 120 may receive the NFT request, and the transmission destination address 302 for the generated NFT. The blockchain address 302 may be transmitted to the smart contract 110, 120 after the smart contract 110, 120 has been called.

According to the technique shown in FIG. 21, the user only needs to provide the system 10 (e.g., the smart contract 110, 120) with the blockchain address 302 to be the transmission destination of the generated NFT, so that the user need not provide the system 10 (e.g., the smart contract 110, 120) with its own private key 301 for NFT generation. Therefore, confidentiality of the private key 301 of the user can be easily secured.

Since the private key used for NFT generation is not the private key 301 possessed by the user but the private keys Key1, Key2, Key3 possessed by the system 10, the owner of the NFT is the system 10 at the time of generation of the NFT. However, since the generated NFT is transmitted to the address 302 of the user, the owner of the generated NFT is the user.

The present invention is not limited to the above embodiments, and various modifications can be made.

The system according to the embodiment may be a system as follows. That is, the system according to the embodiment is a non-fungible token generation system configured to execute a process of generating a non-fungible token, and may include a database including a plurality of material data. The process of generating the non-fungible token may include: upon receiving a non-fungible token request, selecting data from among the plurality of material data included in the database at random or according to a predetermined rule; and generating a non-fungible token by using the selected data.

The method according to the embodiment may be a method as follows. That is, the method according to the embodiment is a non-fungible token generation method executed by a non-fungible token generation system, and the non-fungible token generation system may include a database including a plurality of material data. The method may include: upon receiving a non-fungible token request, selecting data from among the plurality of material data included in the database at random or according to a predetermined rule; and generating a non-fungible token by using the selected data.

### REFERENCE SIGNS LIST

10 non-fungible token generation system
20 non-fungible token generation system
30 non-fungible token generation system
50 non-fungible token generation system
60 non-fungible token generation system
70 non-fungible token generation system
100 computer network system
101 smart contract
102 ticket issuance smart contract
103 warranty certificate issuance smart contract
110 first smart contract
111 first module
112 second module
113 third module
114 fourth module
115 fifth module
116 number-of-fungible-tokens determination module
117 NFT type determination module
120 second smart contract
200 server
210 processor
212 NFT configuration data incorporation process
215 reservation acceptance process
220 memory
230 database
240 NFT material data (material data database)
245 configuration data database
250 NFT generation rule
260 computer program
300 user terminal (user computer)
301 private key
302 blockchain address
310 operation screen
311 button
312 button
313 button
314 button
315 button
350 server (application server; user computer)
C1 category
C2 category
C3 category
D1 image data
D2 image data
D3 image data
M number of category data
N number of image data
P issuance number
T type

1. A non-fungible token generation system configured to execute:
receiving a non-fungible token request having identification information;
identifying a type of a target non-fungible token to be generated, based on the identification information possessed by the non-fungible token request;
generating the target non-fungible token of the identified type; and
transmitting the generated target non-fungible token,
the non-fungible token generation system being capable of generating a plurality of types of target non-fungible tokens.

2. The non-fungible token generation system according to claim 1, wherein
receiving the non-fungible token request includes receiving a request transmission token that is a fungible token or a non-fungible token, and
the type of the target non-fungible token is identified by using, as the identification information, the number or type of the request transmission tokens.

3. The non-fungible token generation system according to claim 2, being configured to be able to receive both a fungible token and a non-fungible token as the request transmission token, wherein
when the fungible token has been received as the request transmission token, the type of the target non-fungible token is identified based on the number of the fungible tokens having been received as the request transmission token, and
when the non-fungible token has been received as the request transmission token, the type of the target non-fungible token is identified based on the type of the non-fungible token having been received as the request transmission token.

4. The non-fungible token generation system according to any one of claims 1 to 3, comprising a contract computer that executes a smart contract on a blockchain,
the smart contract being configured to cause the contract computer to execute:
receiving a non-fungible token request having the identification information;
identifying the type of the target non-fungible token to be generated, based on the identification information possessed by the non-fungible token request;
generating the target non-fungible token of the identified type; and
transmitting the generated target non-fungible token.

5. The non-fungible token generation system according to any one of claims 1 to 4, wherein
generating the target non-fungible token includes generating the target non-fungible token by using data that is selected based on the received identification information from among a plurality of material data.

6. The non-fungible token generation system according to claim 5, wherein
the target non-fungible token has an identifier indicating duplicate data of the selected data.

7. The non-fungible token generation system according to claim 6, wherein
the identifier indicating the duplicate data is a uniform resource identifier indicating the duplicate data.

8. The non-fungible token generation system according to any one of claims 1 to 7, being configured to further execute identifying the number of the target non-fungible tokens to be generated, based on the identification information.

9. The non-fungible token generation system according to any one of claims 1 to 8, wherein
receiving the non-fungible token request includes receiving a request transmission token that is a non-fungible token, and
the non-fungible token that is the request transmission token has the identification information used for identifying the type of the target non-fungible token to be generated.

10. The non-fungible token generation system according to any one of claims 1 to 9, wherein
the identification information possessed by the non-fungible token request includes data indicating any of the plurality of material data.

11. The non-fungible token generation system according to any one of claims 1 to 10, being configured to:
include a generation private key for generating the target non-fungible token; and
generate the target non-fungible token by using the generation private key.

12. A non-fungible token generation system configured to execute a process of generating a non-fungible token,
the system including a database including a plurality of material data,
the process of generating the non-fungible token comprising:
receiving a non-fungible token request having identification information; and
generating a non-fungible token by using data that is selected based on the received identification information from among the plurality of material data included in the database.

13. The non-fungible token generation system according to claim 12, being configured to:
include a generation private key for generating the non-fungible token; and
generate the non-fungible token by using the private key.

14. A non-fungible token generation method executed by a non-fungible token generation system, the method comprising:
receiving a non-fungible token request having identification information;
generating a target non-fungible token of a type that is identified based on the identification information possessed by the non-fungible token request; and
transmitting the generated target non-fungible token.

15. A non-fungible token generation method executed by a non-fungible token generation system,
the non-fungible token generation system including a database including a plurality of material data,
the method comprising:
receiving a non-fungible token request having identification information; and
generating a non-fungible token by using data that is selected based on the received identification information from among the plurality of material data included in the database.
